(19) United States
(12) Patent Application Publication
(10) Pub. No.: US 2025/0278778 A1
(43) Pub. Date: Sep. 4, 2025

(54) Embedded Articles with Add to Cart Function

(71) Applicant: The Toronto-Dominion Bank, Toronto (CA)

(72) Inventors: Sophie Na-Hyun Park, Toronto (CA); Robert Jonathan Brenneman, Thornbury (CA)

(73) Assignee: The Toronto-Dominion Bank, Toronto, ON (CA)

(21) Appl. No.: 18/595,133

(22) Filed: Mar. 4, 2024

(51) Int. Cl. G06Q 30/0601; H04L 67/306

(52) U.S. Cl. CPC G06Q 30/0641; H04L 67/306

(57) ABSTRACT

An example operation may include one or more of generating an article of content based on execution of an artificial intelligence (AI) model on contextual attributes of a user and a plurality of articles stored within a data store, embedding a product within the article of content, displaying the article of content via a user interface of a user device and embedding an add to cart function associated with the product into the user interface, detecting an input with respect to the add to cart function displayed within the user interface, and in response to the detected input, displaying a notification on the user interface with a cart that includes the product therein.

### BACKGROUND

To help educate consumers, institutions often provide literature that the consumers can read and use for educational purposes. Examples of such literature include articles about buying a first home, saving for a college education, receiving a loan for a small business, and many other interests. However, consumer buying power is more diverse than ever, and the literature is often generic. As a result, the educational materials may provide hints to a user about the next steps to take but may not contain recommended actions that are specific to the consumer's current situation. Instead, the consumer must attempt to figure out what do to on their own (e.g., reading additional literature, comparing options, getting guidance from customer support team, etc.)

### SUMMARY

One example embodiment provides an apparatus that may include one or more of store a plurality of articles of content within a data store, ingest user data from an external data source, wherein the user data comprises contextual attributes of a user, fuse together content from an article among the plurality of articles and the user data to generate a fused article based on execution of an artificial intelligence (AI) model on the contextual attributes of the user and the content from the article, embed a clickable link to a web page within a body of the fused article, and display the fused article on a user device of the user.

Another example embodiment provides a method that includes one or more of storing a plurality of articles of content within a data store, ingesting user data from an external data source, wherein the user data comprises contextual attributes of a user, fusing together content from an article among the plurality of articles and the user data to generate a fused article based on execution of an artificial intelligence (AI) model on the contextual attributes of the user and the content from the article, embedding a clickable link to a web page within a body of the fused article, and displaying the fused article on a user device of the user.

A further example embodiment provides a computer-readable medium comprising instructions, that when read by a processor, cause the processor to perform one or more of storing a plurality of articles of content within a data store, ingesting user data from an external data source, wherein the user data comprises contextual attributes of a user, fusing together content from an article among the plurality of articles and the user data to generate a fused article based on execution of an artificial intelligence (AI) model on the contextual attributes of the user and the content from the article, embedding a clickable link to a web page within a body of the fused article, and displaying the fused article on a user device of the user.

A further example embodiment provides an apparatus that may include one or more of generate an article of content based on execution of an artificial intelligence (AI) model on contextual attributes of a user and a plurality of articles stored within a data store, embed a product within the article of content, display the article of content via a user interface of a user device and embed an add to cart function associated with the product into the user interface,
detect an input with respect to the add to cart function displayed within the user interface, and in response to the detected input, display a notification on the user interface with a cart that includes the product therein.

A further example embodiment provides a method that includes one or more of generating an article of content based on execution of an artificial intelligence (AI) model on contextual attributes of a user and a plurality of articles stored within a data store, embedding a product within the article of content, displaying the article of content via a user interface of a user device and embedding an add to cart function associated with the product into the user interface, detecting an input with respect to the add to cart function displayed within the user interface, and in response to the detected input, displaying a notification on the user interface with a cart that includes the product therein.

A further example embodiment provides a computer-readable medium comprising instructions, that when read by a processor, cause the processor to perform one or more of generating an article of content based on execution of an artificial intelligence (AI) model on contextual attributes of a user and a plurality of articles stored within a data store, embedding a product within the article of content, displaying the article of content via a user interface of a user device and embedding an add to cart function associated with the product into the user interface, detecting an input with respect to the add to cart function displayed within the user interface, and in response to the detected input, displaying a notification on the user interface with a cart that includes the product therein.

### BRIEF DESCRIPTION OF THE DRAWINGS

FIG. 1 is a diagram illustrating an artificial intelligence (AI) computing environment for generating infused smart articles according to example embodiments.

FIG. 2 is a diagram illustrating a process of executing a machine-learning model on input content according to example embodiments.

FIGS. 3A-3C are diagrams illustrating processes for training a machine learning model according to example embodiments.

FIG. 4 is a diagram illustrating a process of prompting a generative artificial intelligence (GenAI) model to generate graphical user interface (GUI) content according to example embodiments.

FIGS. 5A-5D are diagrams illustrating a process of generating a smart article infused with user data according to example embodiments.

FIG. 6 is a diagram illustrating a process of ingesting user data for generating a fused smart article according to example embodiments.

FIGS. 7A-7C are diagrams illustrating a process of embedding an add to cart function within an article of content according to example embodiments.

FIG. 8A is a diagram illustrating a method of generating a smart article infused with user content and an embedded link according to example embodiments.

FIG. 8B is a diagram illustrating a method of generating an article of content with an add to cart function according to example embodiments.

FIG. 8C is an example flow diagram according to example embodiments.

FIG. 8D is another example flow diagram according to example embodiments.

FIG. 9 is a diagram illustrating a computing system that may be used in any of the example embodiments described herein.

### DETAILED DESCRIPTION

It is to be understood that although this disclosure includes a detailed description of cloud computing, implementation of the instant solution recited herein is not limited to a cloud computing environment. Rather, embodiments of the instant solution are capable of being implemented in conjunction with any other type of computing environment now known or later developed.

The example embodiments are directed to a platform that can ingest user data from both local and external sources, and generate an article of content (e.g., literature, etc.) that is infused with both real content from an existing article and user data that is specific to the user reading the article of content. The process may be performed based on execution of an artificial intelligence (AI) model. The AI model may be trained on a large corpus of articles and can generate articles of content based on the training. In addition, the AI model may be trained on user data. As a result of the training, the AI model may understand how to generate a new article of content with user data infused therein.

By infusing user data into an article of content, the article becomes more specific to the user's needs and interests. For example, if the user is interested in purchasing a home, the AI model may infuse user-specific actions into an article about purchasing a home that can help the user improve their chances of purchasing a home given their current situation. For example, the AI model may detect the user has a low credit score and suggest actions to take to improve their credit score which can be infused into an article about purchasing a home for a first-time home buyer. This is just one simple example, and many are possible.

As another example, the AI model may embed products into an article of content. The products may also be specific to both the article of content and the user's current situation. Furthermore, the products may be selectable from the article when displayed on a user's device. For example, the article may include an add to cart function that can be selected by a user reading the article to add the embedded product to a shopping cart. The user can then checkout/complete their enrollment or purchase of the product through the shopping cart.

According to various embodiments, the AI model may be a generative AI (GenAI) model such as a large language model (LLM) or a multimodal large language model. As another example, the GenAI model may be a transformer neural network (“transformer”), or the like. The AI model may be trained to understand how to generate a new article of content from existing articles and to infuse user data into the new article of content. To do this, the AI model may take content from one or more articles of content, combine them into a single article, and infuse new content into the article that is specific to the user. Here, the AI model may include libraries and/or deep learning frameworks that enable the AI model to create realistic articles of content and display them as web pages.

The user data may include contextual information that the AI model can use to understand a current situation of the user such as a user's work history, a user's family information, a user's financial information, a user's interests, and the like. By ingesting the user's information, the AI model can generate new content that can be added to an existing article that is specific to a user's situation. As a result, the article of content can be narrowly tailored to the particular user's situation.

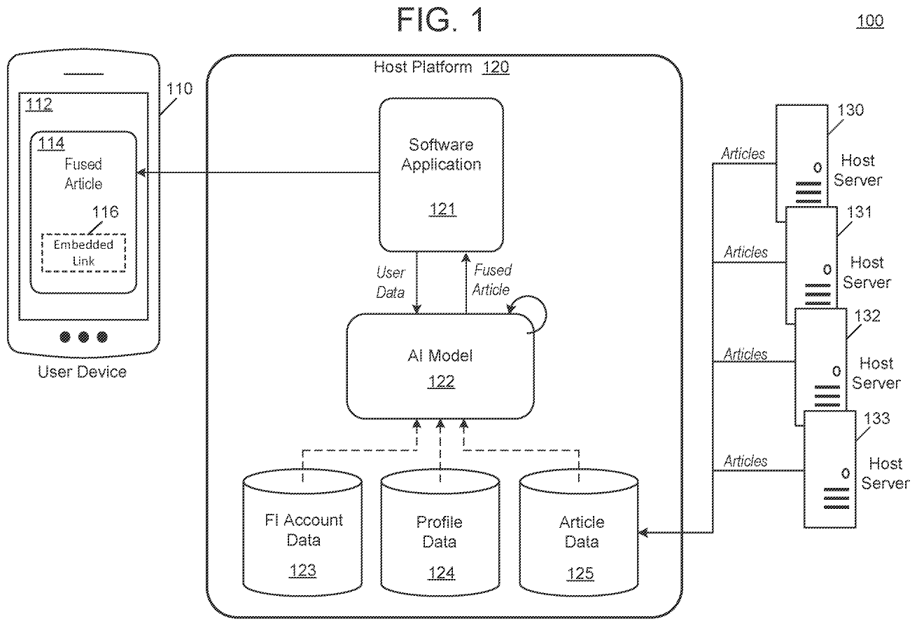

FIG. 1 illustrates an artificial intelligence (AI) computing environment 100 for generating fused smart articles according to example embodiments. Referring to FIG. 1, a host platform 120, such as a cloud platform, web server, etc., may host a software application 121 that outputs literature such as articles of content. In this example, a user may access the software application 121 with a user device 110 by connecting the user device 110 to the host platform 120 over a computer network. As an example, the user device may include a mobile device, a computer, a laptop, a desktop computer, or the like. The user device 110 may include a user interface 112 where articles of content can be displayed by the software application 121.

In the example of FIG. 1, the software application 121 outputs a fused article 114 with an embedded link 116. The fused article 114 may include content that is extracted from one or more existing articles and fused together with user-specific data that provides a user-specific article of content. The embedded link 116 may include a hyperlink or other interactive user interface element that when selected navigates the user interface 112 to a different page such as a different web page, page of the software application, and/or the like.

Here, the host platform 120 may host the software application 121 and make it accessible to the user device 110 over a computer network such as the Internet. For example, the software application 121 may be a mobile application that includes a front-end which is installed on the user device 110 and a backend which is installed on the host platform 120. As another example, the software application 121 may be a progressive web application (PWA) that is hosted by the host platform 120 and made accessible via a browser on the user device 110.

In the example embodiments, the host platform 120 may include one or more artificial intelligence (AI) models including an AI model 122 which is capable of ingesting articles of content from different sources including external host servers 130, 131, 132, and 133 during a training process. For example, the host platform 120 may crawl the websites such as those hosted by the external host servers 130, 131, 132, and 133, extract articles of content from publicly available websites, and store them in a data store 125. In addition, the AI model 122 may also ingest user data such as financial account data of the user from a data store 123, profile data such as social media data and the like from a data store 124, and the like. The host platform 120 may also include one or more additional models including one or more machine learning models, one or more artificial intelligence (AI) models, one or more additional GenAI models, and the like. The models including the AI model 122 may be held by the host platform 120 within a model repository (not shown).

In this example, the AI model 122 may be trained to generate articles of content. That is, the AI model 122 may be a generative AI model that can generate new articles of content by fusing together content from one or more existing articles of content and user data. In this example, the AI model 122 may be trained based on articles of content that are downloaded by the host platform 120 from publicly available sources on the web, and the like. The AI model 122 may be trained to generate content that can be depicted on the user interface 112 of the user device 110. For example, the AI model 122 may be trained based on web pages that include articles describing financial products and financial advice, however, embodiments are not limited thereto. As another example, the articles may be related to other areas such as sports, news, entertainment, and the like. In addition to ingesting articles of content during the training process, the AI model 122 may also ingest user data from a community of users which can be used to train the AI model to fuse together user-specific data and article content to create a fused article of content. The user data may include social media account data, reviews posted online by users, blogs, browsing history, financial account transactions, financial account profiles, user profiles, family information, and the like.

After the AI model 122 is trained, the AI model 122 may be queried by the software application 121 to generate an article of content. For example, when a user opens a web page and requests to view an article of content, an identifier of the user, such as a user ID, a username, an email address, a phone number, a media access control (MAC) address of the user device, or some other credential associated with the user, may be transmitted to the software application 121 from the user device 110. Based on the user identifier, the software application 121 may query any of the data stores 123 and 124 for user data that matches the user identifier and input the user data to the AI model 122. The user data may be pulled from an external data source not shown in the example of FIG. 1. As another example, the user data may be extracted from a user profile or a financial account of the user hosted by the host platform 120, browsing data from the user device 110, family data of the user from a social media site, etc. During this process, the AI model 122 may generate a custom article that includes both existing article content from one or more articles stored in the data store 125 with user-specific content infused into the article.

In one embodiment, the system utilizes an advanced AI model to offer users highly personalized health and wellness advice. The system collects a comprehensive range of user data from fitness trackers or smartwatches, including basic health metrics like age, weight, and height. More behavioral data, such as dietary habits, sleep patterns, and exercise routines, are gathered through integrations with various health applications and questionnaires filled out by the user. For those who consent, the platform can incorporate medical history details and genetic information from partnered healthcare providers or genetic testing services. The AI model is trained on a vast database of health and wellness content. The database includes general health articles and blogs, in-depth research papers, medical journals, and expert columns covering various topics, from nutrition and fitness to mental health and preventive care. The AI model uses natural language processing and machine learning techniques to understand the nuances of this content and how it relates to different health profiles. When generating personalized content, the AI model considers the user's specific health goals-weight loss, muscle gain, managing a chronic condition, or staying healthy. It includes dietary restrictions and preferences, such as veganism or gluten intolerance. The content includes interactive meal plans, workout routines, stress management techniques, and tailored meditation and yoga sessions. The AI model continuously learns and refines its content generation as users interact with the content, provide feedback, and update their health data. The system also has community features, allowing users to connect with others with similar health goals or challenges.

In one embodiment, the system leverages AI technology to offer personalized career guidance and educational resources. The system assists individuals in navigating their professional paths and educational opportunities. It gathers detailed user data, including employment history, educational background, current skill set, and professional interests. The information is sourced from users' profiles on professional networking sites, resume uploads, or direct input through interactive questionnaires on the platform. The AI model considers aspects like career aspirations, preferred work culture, and long-term professional goals from user interactions and feedback within the platform. The AI model is trained on diverse content, ranging from career development articles and job market reports to educational resources and industry-specific research. The training enables the AI model to understand current industry trends, identify emerging skill requirements, and recognize patterns in career progression. When generating personalized content, the AI model utilizes its understanding of the user's profile to create tailored career advice, including recommendations for specific job roles or industries where the user's skills and interests are a good fit. The system also suggests networking strategies, mentorship opportunities, and professional groups and associations to join for career advancement. Additionally, the system offers educational guidance by aligning the user's career trajectory with relevant courses, certifications, or degree programs. It recommends online courses to fill skill gaps, suggests local or online degree programs for career advancement, or identifies workshops and seminars for continuous professional development. The system is responsive to changing job markets and individual career progressions. As users update their profiles with new skills, job changes, or educational achievements, the AI model recalibrates its recommendations, ensuring that the advice remains relevant and actionable. Furthermore, the system incorporates a community feature, allowing users to share experiences, provide insights, and support each other.

In one embodiment, the system provides tailored financial and investment advice to its users. The system aggregates a wide range of financial data from each user. The data includes basic information such as income, expenses, and savings, alongside more complex data like investment portfolios, risk tolerance levels, and long-term financial objectives. It integrates with banking and investment platforms and financial planning tools to gather comprehensive and up-to-date financial profiles of its users. The AI model is trained on diverse financial content, including real-time financial news, stock market reports, investment strategy articles, and economic research papers. The training allows the AI model to learn the intricacies of the financial markets, understand different investment products, and stay updated with the latest economic trends and policies. When creating personalized content, the AI model considers the individual's financial data and goals. For instance, for a user aiming for retirement savings, the AI model might generate content focusing on long-term investment strategies, pension plans, and tax-efficient saving methods. For someone interested in aggressive growth, it might focus on high-risk, high-reward investment options, such as stocks, cryptocurrencies, or emerging market funds. Additionally, the system offers dynamic and responsive advice. As financial markets fluctuate and users update their financial information or modify their goals, the AI model adapts its content accordingly to ensure that the advice remains relevant and in line with the latest market conditions. Users can input different financial scenarios to see potential outcomes, helping them understand the implications of various investment decisions. This feature uses historical data and market simulations to provide insights into how certain investments might perform under different economic conditions.

In one embodiment, the system uses AI to offer personalized guidance and support to parents and caregivers. The system collects detailed information about the family, primarily focusing on the children and parenting styles. The data includes the ages and developmental stages of the children, health and educational records, interests and hobbies, and the parents' philosophies and approaches to childcare. Additional data is gathered through questionnaires and direct inputs from the parents, encompassing aspects like family routines, challenges faced, and specific areas where guidance is sought. The AI model powering the system is trained on a vast and diverse range of parenting-related content, including child psychology research, educational methodologies, parenting blogs, and articles on child health and wellbeing. The AI model's training enables it to understand the complexities of child development and various parenting approaches, ensuring that the advice it generates is scientifically grounded and practically applicable. When generating personalized content, the AI model considers the family's unique profile. For example, for families with toddlers, the AI model might generate articles on effective toilet training methods, dealing with tantrums, or fostering early literacy skills. For parents of teenagers, the content may focus on navigating emotional changes, fostering independence, or dealing with academic pressures. The system also recognizes that parenting is not a static journey; as children grow and family dynamics evolve, the challenges and needs of parents change. Therefore, the system adapts its advice and suggestions over time based on continuous feedback and updated user information. A key feature of the system is its community aspect. Parents can connect with others in similar situations, share experiences, and offer support. The peer-to-peer interaction allows the AI model to identify common challenges and effective strategies, further refining the personalization of its advice.

In one embodiment, the system leverages AI to create a personalized travel itinerary aligned with the user's travel preferences and interests. The system gathers detailed information about the user's travel preferences and history. This includes data on preferred destinations, types of activities enjoyed (e.g., adventure sports, cultural tours, relaxation), budget constraints, travel durations, and any specific interests like culinary experiences, historical sites, or nature exploration. Users can input information directly, or the system can infer preferences from past travel bookings and reviews if linked with travel booking sites or social media. The AI model is trained on travel-related content, from travel blogs and destination guides to cultural articles and local event information. It integrates real-time data, including weather forecasts, local events, and seasonal attractions, ensuring the recommendations are personalized and contextually relevant. The AI model creates personalized travel itineraries aligned with the user's interests and preferences. For example, for a user interested in history and culture, the AI model might suggest an itinerary focusing on historical landmarks, museums, and cultural shows in a city like Rome or Kyoto. It creates a plan for adventure seekers featuring hiking trails, scuba diving spots, and adventure parks in destinations known for their natural landscapes. The system also offers insights into local customs, language tips, and culinary recommendations not typically found in standard travel guides, allowing users to immerse themselves more deeply in the local culture. The system adjusts recommendations based on changes in weather, local events, and the user's current location during the trip, ensuring the experience remains seamless and responsive to the traveler's immediate context. The system offers a community feature, allowing travelers to share their experiences, tips, and reviews.

In one embodiment, the system utilizes an AI model to combine article content and user data to create a unique article. The system stores a wide variety of articles of content covering a range of topics as the source from which customized, user-specific content can be generated. Additionally, the system ingests user data from external data sources. The user data includes demographic information and contextual attributes of the user, encompassing browsing history, financial transaction records, social media activity, etc. The AI model combines content from one of the stored articles with the ingested user data. The outcome is an ‘infused article’—a personalized, contextually relevant piece of content that aligns closely with the user's specific circumstances and interests. The system embeds a clickable link within the body of the infused article. The link redirects users to a web page that provides further information, services, and actions related to the article's content. Finally, the system ensures that the infused article, complete with the embedded clickable link, is displayed on the user's device. The device can be a mobile phone, a tablet, or a computer, and the display is facilitated through a user interface that is part of a software application. When a user requests to view an article, an identifier (such as an email, phone number, or username) is transmitted to the software application. The application, in turn, communicates with the AI model, providing the necessary user data. The AI model accesses the stored articles in the memory, selects relevant content, and fuses it with the user data, creating a custom, infused article. The article is sent back through the application and displayed on the user's device.

In one embodiment, the system integrates an AI model to offer users tailored fitness and nutrition advice. Users provide detailed personal information to the system, including current fitness levels, health metrics (weight, height, and age), dietary preferences (allergies or dietary restrictions), and specific health or fitness goals (weight loss, muscle building, improved endurance, etc.). Additionally, users input their daily schedules to allow the system to suggest meal and workout plans that fit their lifestyle. The AI model processes the user data and combines it with its extensive knowledge base to generate personalized fitness and nutrition articles. The articles are informative and highly actionable, including custom workout routines tailored to the user's fitness level and goals, complete with step-by-step instructions, suggested repetitions, and necessary precautions to avoid injuries. For nutrition, the articles offer meal plans aligned with the user's dietary preferences and nutritional needs, considering their health goals and specific dietary restrictions. A feature of the system is the embedded “add to cart” function within the articles. The feature allows users to purchase related products or services directly. For instance, the articles may include links to buy dietary supplements, health foods, or fitness equipment, or to enroll in specialized workout programs or diet plans. The system learns from user feedback and progress, adjusting future recommendations to reflect changes in the user's fitness levels, dietary habits, or goals to ensure that the advice remains relevant and effective over time. The system also fosters a sense of community by optionally allowing users to share their progress, experiences, and tips with others, creating a supportive environment for achieving health and fitness goals.

In one embodiment, the system uses an AI model to generate educational articles for students. Students provide detailed input about their academic profiles. Details include their current educational level, subjects of study, areas of interest, and academic performance history. Students can also input specific learning objectives, such as mastering a concept or preparing for an exam. Additionally, the system integrates with educational platforms to import grades and teacher feedback, providing a more comprehensive view of the student's learning needs. Once the student's profile is established, the AI model processes the information and cross-references it with its comprehensive educational database to generate educational articles and resources. The content is interactive and designed to cater to the unique learning style of each student. It can include visual aids for visual learners, interactive simulations for kinesthetic learners, and in-depth texts for those who prefer detailed reading. The system embeds an “add to cart” function within the generated educational articles. This feature enables students to directly access and purchase supplementary educational materials, enroll in recommended online courses, or buy books and resources aligned with the article's content. Furthermore, the system adapts to the student's progress and adjusts future content and resource recommendations based on their evolving educational needs and feedback. The system integrates community features, where students can discuss concepts, share resources, and provide peer support.

In one embodiment, the system utilizes an AI model to offer personalized guidance for home renovation and decoration projects. The system utilizes an AI model trained on a vast database that includes a wide range of home improvement and interior design concepts, styles, techniques, and practical information about materials, costs, and do-it-yourself (DIY) strategies. Users provide the system with specifics about their living space, such as room dimensions, existing layout, lighting conditions, and any existing furniture or decor. They also share their style preferences, budget constraints, and desired functionalities for each space. For example, a user might specify a need for a child-friendly living room, a kitchen remodel, or a desire for a minimalistic bedroom design. The system processes the input and consults its extensive knowledge base to generate custom articles and guides. It offers design suggestions, color palette choices, furniture placement ideas, and DIY home improvement tips tailored to the user's specific requirements and personal style. The articles include visual renderings and interactive elements like virtual room designs, providing users with a clear vision of potential renovations or decor changes. The system integrates an “add to cart” function within the articles, allowing users to purchase furniture, home decor items, or DIY tools and materials recommended. It also enables booking services from interior designers, contractors, or other professionals. The system is dynamic and continually evolves based on user interaction. As users provide feedback on the suggestions or update their preferences and requirements, the AI model recalibrates to offer more precise and relevant advice in future articles.

In one embodiment, the system generates personalized travel articles for users. The system utilizes an AI model trained on diverse travel-related content, including destination guides, cultural insights, adventure sports information, gastronomic databases, and real-time data like weather forecasts and local events. Users interact with the system by inputting detailed information about their travel preferences. This includes favored destinations, types of activities they enjoy (such as cultural tours, adventure sports, relaxation, etc.), budget constraints, travel durations, and any specific interests like culinary experiences, historical sites, or nature exploration. The system infers preferences from past travel bookings and reviews linked with travel booking sites or users' social media profiles. Based on the user input, the AI model generates personalized travel itineraries. The itineraries are comprehensive guides tailored to the user's unique travel profile. For instance, for a history enthusiast, the itinerary might include a detailed walk-through of historical landmarks, museums, and cultural shows in cities rich in culture. For adventure seekers, it may suggest a mix of hiking trails, scuba diving spots, and other adventure activities, complete with safety tips and the best times to visit. An essential aspect of the system is the integration of an “add to cart” function within the itineraries. This feature allows users to book flights, reserve accommodations, purchase tickets for attractions, and enroll in unique local experiences directly from the itinerary. The system continuously updates its recommendations based on changing factors such as weather conditions, local events, or user feedback during the trip. Additionally, the system incorporates a community feature, allowing travelers to share experiences, tips, and reviews of destinations, accommodations, and activities.

In one embodiment, the system leverages an AI model to generate personalized fashion assistance articles. The system uses an AI model trained on an extensive range of fashion-related content, including current trends, classic styles, body type dressing guides, and accessory matching and catering to individual style preferences, body shapes, and lifestyle needs. Users provide detailed information about their fashion preferences, body measurements, and lifestyle. This can include preferred styles (casual, professional, avant-garde, etc.), color preferences, typical social and professional environments, and specific wardrobe challenges (dressing for a new job or body changes). Users can also upload photos of their existing wardrobe items, allowing the AI model to understand their current collection and suggest additions or alterations. The AI model processes the information and uses its fashion knowledge to generate personalized fashion articles and style guides. The guides include suggestions on how to mix and match existing wardrobe items to create new outfits, advice on dressing for different body types, and recommendations for season-appropriate clothing. The content is tailored to each user's unique style, helping them enhance their style and confidently dress for various occasions. A feature of the system is the “add to cart” function embedded within the articles. This allows users to purchase clothing items and accessories directly or book appointments with fashion consultants or personal stylists that the AI model recommends. The system can link to online retailers and local boutiques, providing a wide range of shopping options matching the user's style and budget. The system dynamically evolves with the user's changing style and needs. As users provide feedback on the recommendations or update their profiles with new preferences or lifestyle changes, the AI model adapts to offer continuously updated and relevant fashion advice. Additionally, the system includes a community feature so users can share their fashion experiences, post outfit photos, and exchange style tips.

In one embodiment, the system utilizes an AI model trained on article content to generate a new article of content. The system stores a plurality of content articles within a data store, ingests user data from an external data source, and fuses content from an article with user data to generate an infused article. The articles cover various topics, such as health and wellness, financial advice, career guidance, parenting support, travel recommendations, etc., and are sourced from multiple platforms. The system utilizes an AI model, which considers the user's contextual attributes and the articles' content. Additionally, the system is designed to embed a clickable link within the infused article and display it on a user's device. The system accesses the stored content, selecting relevant articles based on user profiles and interests. User data is ingested from various external sources, including but not limited to social media platforms, professional networking sites, user profiles, financial accounts, and health-tracking applications. The data encompasses a wide range of contextual attributes like employment history, financial status, health metrics, and personal interests. The system fuses the user data with content from the selected articles to create a custom, user-specific infused article. The AI model, a central system component, employs advanced machine learning and natural language processing techniques. It is trained on diverse content and user data, enabling it to understand and interpret the nuances of the articles and the user's profile. The AI model fuses the article content with the user data, creating an infused article that is highly personalized and relevant to the user's current situation. The system also includes a functionality to embed clickable links within the body of the infused article. The links lead to web pages that provide further information, services, or actions related to the article's content. The infused article, complete with the embedded clickable link, is displayed on the user's device. The user's device can be a mobile phone, a tablet, or a computer, and it interfaces with the system through a software application. The application transmits the user's identifier (such as an email address, phone number, or username) to the system. Upon receiving a request to view an article, the system leverages the AI model to process the user's data, select and fuse the relevant article content, and then display the final infused article on the user's device.

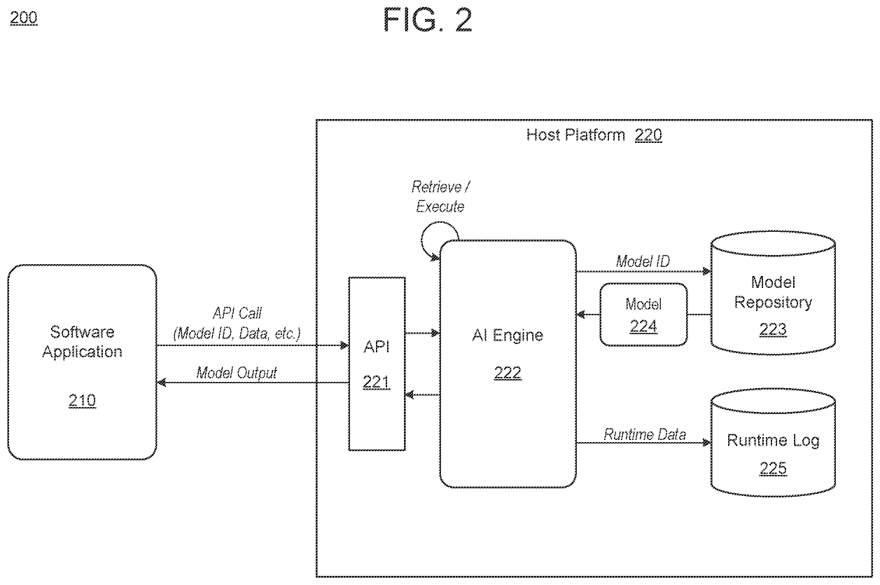

FIG. 2 illustrates a process 200 of executing a model 224 on input content according to example embodiments. As an example, the model 224 may be a generative AI model, however, embodiments are not limited thereto. Referring to FIG. 2, a software application 210 may request execution of the model 224 by submitting a request to the host platform 220. For example, the request may include an API call or other submission identifiers of model data such as an identifier of the model to be executed, a payload of data to be input to the model during execution, an expected output, a storage location for the expected output, and the like. In response, an AI engine 222 may receive the request, retrieve the model 224 from a model repository 223, and trigger the model 224 to execute within a runtime environment of the host platform 220.

In FIG. 2, the AI engine 222 may control access to models that are stored within the model repository 223. For example, the models may include AI models, machine learning models, neural networks, and/or the like. The software application 210 may trigger execution of the model 224 from the model repository 223 via invocation to an API 221 (application programming interface) of the AI engine 222. The request may include an identifier of the model 224 such as a unique ID assigned by the host platform 220, a payload of data (e.g., to be input to the model during execution), and the like. The AI engine 222 may retrieve the model 224 from the model repository 223 in response and deploy the model 224 within a live runtime environment. After the model is deployed, the AI engine 222 may execute the running instance of the model 224 on the payload of data and return a result of the execution to the software application 210.

In some embodiments, the payload of data may be a format that is not capable of being input to the model 224 nor read by a computer processor. For example, the payload of data may be in text format, image format, audio format, and the like, such as content from a web page or other format where articles are displayed publicly on the Internet. In response, the AI engine 222 may convert the payload of data into a format that is readable by the model 224 such as a vector or other encoding. The vector may then be input to the model 224.

In some embodiments, the software application 210 may display a user interface which enables a user thereof to provide feedback from the output provided by the model 224. For example, a user may input a confirmation that an article generated by the model 224 is relevant to the user's interest. This information may be added to the results of execution and stored within a log 225. The log 225 may include an identifier of the input, an identifier of the output, an identifier of the model used, and feedback from the recipient. This information may be used to subsequently re-train the model by executing the model 224 on the input, the output, the model used, the feedback, and/or the like.

Technological advancements typically build upon the fundamentals of predecessor technologies; such is the case with Artificial Intelligence (AI) models. An AI classification system describes the stages of AI progression. The first classification is known as “Reactive Machines,” followed by present-day AI classification “Limited Memory Machines” (also known as “Artificial Narrow Intelligence”), then progressing to “Theory of Mind” (also known as “Artificial General Intelligence”), and reaching the AI classification “Self-Aware” (also known as “Artificial Superintelligence”). Present-day Limited Memory Machines are a growing group of AI models built upon the foundation of its predecessor, Reactive Machines. Reactive Machines emulate human responses to stimuli; however, they are limited in their capabilities as they cannot typically learn from prior experience. Once the AI model's learning abilities emerged, its classification was promoted to Limited Memory Machines. In this present-day classification, AI models learn from large volumes of data, detect patterns, solve problems, generate and predict data, and the like, while inheriting all of the capabilities of Reactive Machines. Examples of AI models classified as Limited Memory Machines include, but are not limited to, Chatbots, Virtual Assistants, Machine Learning (ML), Deep Learning (DL), Natural Language Processing (NLP), Generative AI (GenAI) models, and any future AI models that are yet to be developed possessing characteristics of Limited Memory Machines. Generative AI models combine Limited Memory Machine technologies, incorporating ML and DL, forming the foundational building blocks of future AI models. For example, Theory of Mind is the next progression of AI that may be able to perceive, connect, and react by generating appropriate reactions in response to an entity with which the AI model is interacting; all of these capabilities rely on the fundamentals of Generative AI. Furthermore, in an evolution into the Self-Aware classification, AI models will be able to understand and evoke emotions in the entities they interact with, as well as possessing their own emotions, beliefs, and needs, all of which rely on Generative AI fundamentals of learning from experiences to generate and draw conclusions about itself and its surroundings. Generative AI models are integral and core to future artificial intelligence models. As described herein, Generative AI refers to present-day Generative AI models and future AI models.

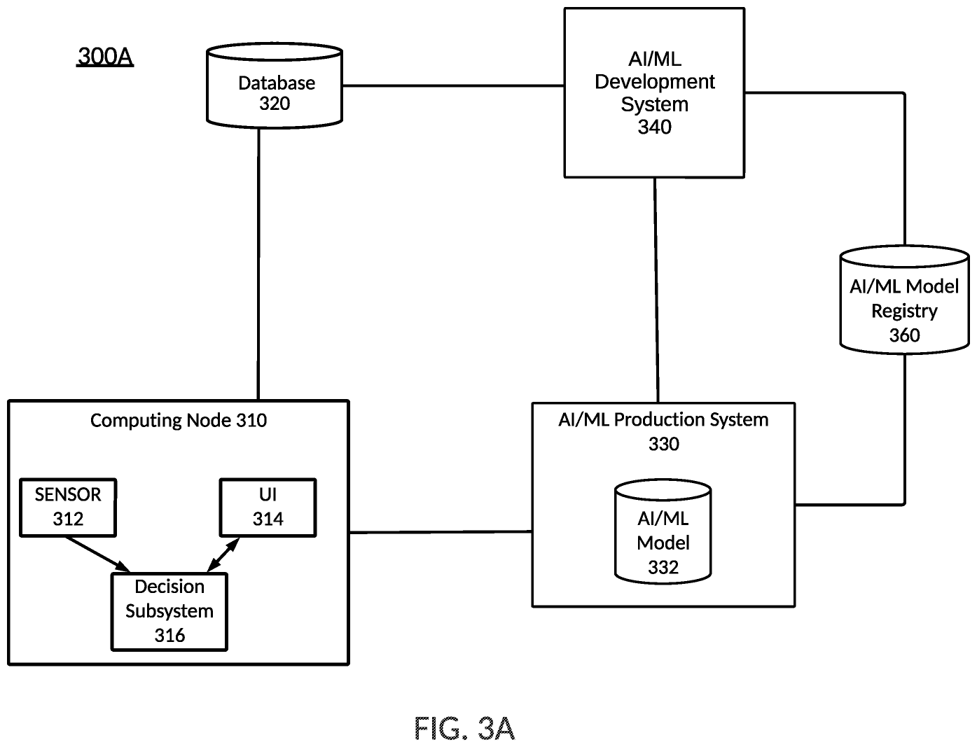

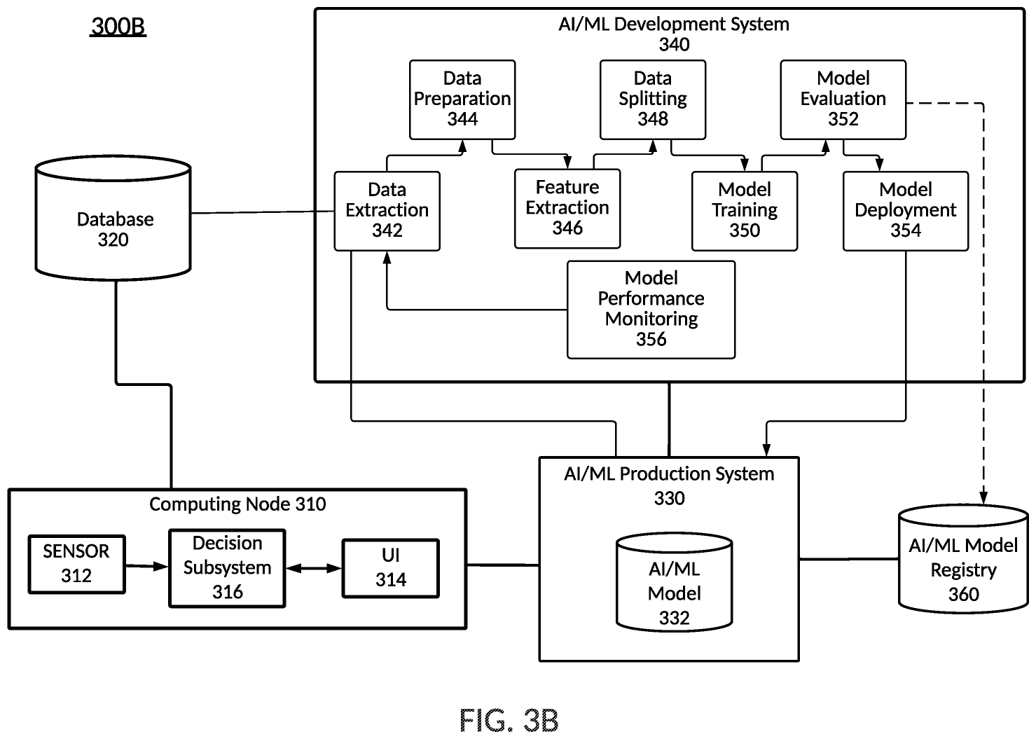

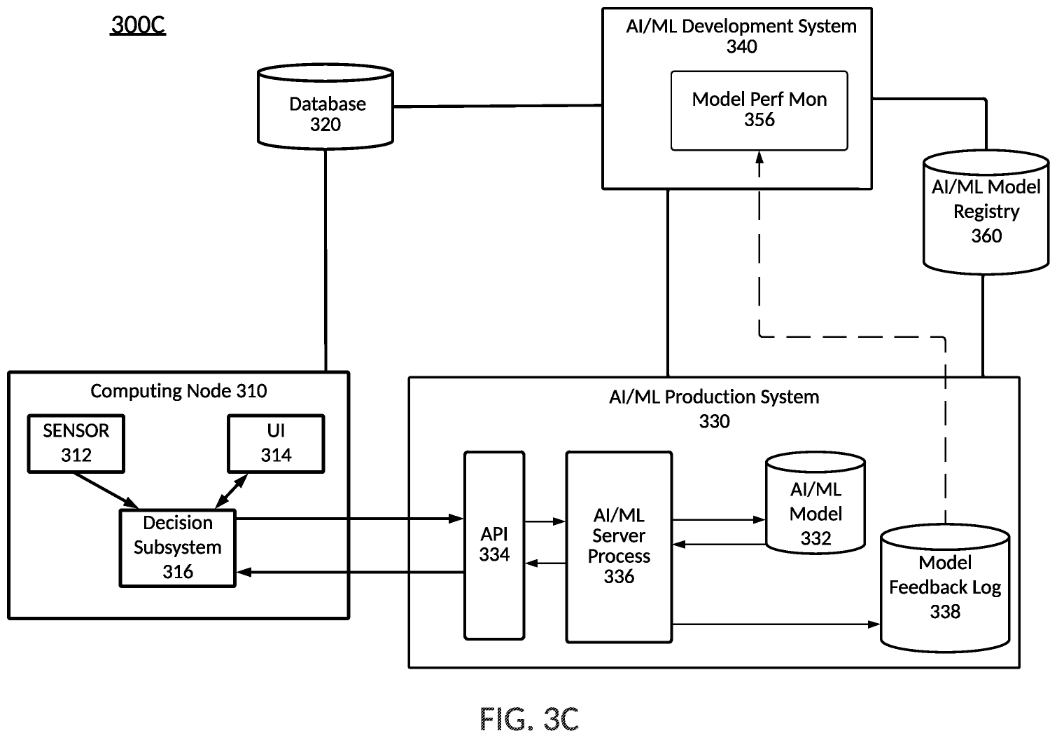

FIG. 3A illustrates an AI/ML network diagram 300A that supports AI-assisted decision points on software executing on a computer. Other branches of AI, such as, but not limited to, computer vision, fuzzy logic, expert systems, neural networks/deep learning, generative AI, and natural language processing, may all be employed in developing the AI model shown in these embodiments. Further, the AI model included in these embodiments is not limited to particular AI algorithms. Any algorithm or combination of algorithms related to supervised, unsupervised, and reinforcement learning algorithms may be employed.

In one embodiment, Generative AI (GenAI) may be used by the instant solution in the transformation of data. Computing nodes 310 may be equipped with diverse sensors that collect a vast array of data. However, raw data, once acquired, undergoes preprocessing that may involve normalization, anonymization, missing value imputation, or noise reduction to allow the data to be further used effectively.

The GenAI executes data augmentation following the preprocessing of the data. Due to the limitation of datasets in capturing the vast complexity of real-world scenarios, augmentation tools are employed to expand the dataset. This might involve image-specific transformations like rotations, translations, or brightness adjustments. For non-image data, techniques like jittering can be used to introduce synthetic noise, simulating a broader set of conditions.

In the instant solution, data generation is then performed on the data. Tools like Generative Adversarial Networks (GANs) and Variational Autoencoders (VAEs) are trained on existing datasets to generate new, plausible data samples. For example, GANs might be tasked with crafting images showcasing situations in uncharted conditions or from unique perspectives. As another example, the synthesis of sensor data may be performed to model and create synthetic readings for such scenarios, enabling thorough system testing without actual physical encounters. Validation might include the output data being compared with real-world datasets or using specialized tools like a GAN discriminator to gauge the realism of the crafted samples.

Computing node 310 may include a plurality of sensors 312 that may include but are not limited to, light sensors, weight sensors, direction sensors, altimeter sensors, etc. In some embodiments, these sensors 312 send data to a database 320 that stores data about the computing node. In some embodiments, these sensors 312 send data to one or more decision subsystems 316 in computing node 310 to assist in decision-making.

Computing node 310 may include one or more user interfaces (UIs) 314, such as a graphical user interface (GUI) executing on the computing node 310. In some embodiments, these UIs 314 send data to a database 320 that stores event data about the UIs 314 that includes but is not limited to selection, state, and display data. In some embodiments, these UIs 314 send data to one or more decision subsystems 316 in computing node 310 to assist decision-making.

Computing node 310 may include one or more decision subsystems 316 that drive a decision-making process around, but are not limited to, a state of software executing on the computing node 310, a location of the computing node, a direction of movement of the computing node, etc. In some embodiments, the decision subsystems 316 gather data from one or more sensors 312 to aid in the decision-making process. In some embodiments, a decision subsystem 316 may gather data from one or more UIs 314 to aid in the decision-making process. In some embodiments, a decision subsystem 316 may provide feedback to a UI 314.

An AI/ML production system 330 may be used by a decision subsystem 316 in a computing node 310 to assist in its decision-making process. The AI/ML production system 330 includes one or more AI/ML models 332 that are executed to retrieve the needed data, such as, but not limited to, a prediction, a categorization, a UI prompt, etc. In some embodiments, an AI/ML production system 330 is hosted on a server. In some embodiments, the AI/ML production system 330 is cloud-hosted. In some embodiments, the AI/ML production system 330 is deployed in a distributed multi-node architecture. In some embodiments, the AI/ML production system resides in computing node 310.

An AI/ML development system 340 creates one or more AI/ML models 332. In some embodiments, the AI/ML development system 340 utilizes data in the database 320 to develop and train one or more AI models 332. In some embodiments, the AI/ML development system 340 utilizes feedback data from one or more AI/ML production systems 330 for new model development and/or existing model re-training. In an embodiment, the AI/ML development system 340 resides and executes on a server. In another embodiment the AI/ML development system 340 is cloud hosted. In a further embodiment, the AI/ML development system 340 utilizes a distributed data pipeline/analytics engine.

Once an AI/ML model 332 has been trained and validated in the AI/ML development system 340, it may be stored in an AI/ML model registry 360 for retrieval by either the AI/ML development system 340 or by one or more AI/ML production systems 330. The AI/ML model registry 360 resides in a dedicated server in one embodiment. In some embodiments, the AI/ML model registry 360 is cloud-hosted. The AI/ML model registry 360 is a distributed database in other embodiments. In further embodiments, the AI/ML model registry 360 resides in the AI/ML production system 330.

FIG. 3B illustrates a process 300B for developing one or more AI/ML models that support AI-assisted decision points. An AI/ML development system 340 executes steps to develop an AI/ML model 332 that begins with data extraction 342, in which data is loaded and ingested from one or more data sources. In some embodiments, computing node data and user data is extracted from a database 320. In some embodiments, model feedback data is extracted from one or more AI/ML production systems 330.

Once the required data has been extracted 342, it must be prepared 344 for model training. In some embodiments, this step involves statistical testing of the data to see how well it reflects real-world events, its distribution, the variety of data in the dataset, etc. In some embodiments, the results of this statistical testing may lead to one or more data transformations being employed to normalize one or more values in the dataset. In some embodiments, this step includes cleaning data deemed to be noisy. A noisy dataset includes values that do not contribute to the training, such as but are not limited to, null and long string values. Data preparation 344 may be a manual process or an automated process using one or more of the elements, functions described or depicted herein.

Features of the data are identified and extracted 346. In some embodiments, a feature of the data is internal to the prepared data from step 344. In other embodiments, a feature of the data requires a piece of prepared data from step 344 to be enriched by data from another data source to be useful in developing an AI/ML model 332. In some embodiments, identifying features is a manual process or an automated process using one or more of the elements, functions described or depicted herein. Once the features have been identified, the values of the features are collected into a dataset that will be used to develop the AI/ML model 332.

The dataset output from feature extraction step 346 is split 348 into a training and validation data set. The training data set is used to train the AI/ML model 332, and the validation data set is used to evaluate the performance of the AI/ML model 332 on unseen data.

The AI/ML model 332 is trained and tuned 350 using the training data set from the data splitting step 348. In this step, the training data set is fed into an AI/ML algorithm and an initial set of algorithm parameters. The performance of the AI/ML model 332 is then tested within the AI/ML development system 340 utilizing the validation data set from step 348. These steps may be repeated with adjustments to one or more algorithm parameters until the model's performance is acceptable based on various goals and/or results.

The AI/ML model 332 is evaluated 352 in a staging environment (not shown) that resembles the ultimate AI/ML production system 330. This evaluation uses a validation dataset to ensure the performance in an AI/ML production system 330 matches or exceeds expectations. In some embodiments, the validation dataset from step 348 is used. In other embodiments, one or more unseen validation datasets are used. In some embodiments, the staging environment is part of the AI/ML development system 340. In other embodiments, the staging environment is managed separately from the AI/ML development system 340. Once the AI/ML model 332 has been validated, it is stored in an AI/ML model registry 360, which can be retrieved for deployment and future updates. As before, in some embodiments, the model evaluation step 352 is a manual process or an automated process using one or more of the elements, functions described or depicted herein.

Once an AI/ML model 332 has been validated and published to an AI/ML model registry 360, it may be deployed 354 to one or more AI/ML production systems 330. In some embodiments, the performance of deployed AI/ML models 332 is monitored 356 by the AI/ML development system 340. In some embodiments, AI/ML model 332 feedback data is provided by the AI/ML production system 330 to enable model performance monitoring 356. In some embodiments, the AI/ML development system 340 periodically requests feedback data for model performance monitoring 356. In some embodiments, model performance monitoring includes one or more triggers that result in the AI/ML model 332 being updated by repeating steps 342-354 with updated data from one or more data sources.

FIG. 3C illustrates a process 300C for utilizing an AI/ML model that supports AI-assisted decision points. As stated previously, the AI model utilization process depicted herein reflects ML, which is a particular branch of AI, but this invention is not limited to ML and is not limited to any AI algorithm or combination of algorithms.

Referring to FIG. 3C, an AI/ML production system 330 may be used by a decision subsystem 316 in computing node 310 to assist in its decision-making process. The AI/ML production system 330 provides an application programming interface (API) 334, executed by an AI/ML server process 336 through which requests can be made. In some embodiments, a request may include an AI/ML model 332 identifier to be executed. In some embodiments, the AI/ML model 332 to be executed is implicit based on the type of request. In some embodiments, a data payload (e.g., to be input to the model during execution) is included in the request. In some embodiments, the data payload includes sensor 312 data from computing node 310. In some embodiments, the data payload includes UI 314 data from computing node 310. In some embodiments, the data payload includes data from other computing node 310 subsystems (not shown), including but not limited to, occupant data subsystems. In an embodiment, one or more elements or nodes 320, 330, 340, or 360 may be located in the computing node 310.

Upon receiving the API 334 request, the AI/ML server process 336 may need to transform the data payload or portions of the data payload to be valid feature values into an AI/ML model 332. Data transformation may include but is not limited to combining data values, normalizing data values, and enriching the incoming data with data from other data sources. Once any required data transformation occurs, the AI/ML server process 336 executes the appropriate AI/ML model 332 using the transformed input data. Upon receiving the execution result, the AI/ML server process 336 responds to the API caller, which is a decision subsystem 316 of computing node 310. In some embodiments, the response may result in an update to a UI 314 in computing node 310. In some embodiments, the response includes a request identifier that can be used later by the decision subsystem 316 to provide feedback on the AI/ML model 332 performance. Further, in some embodiments, immediate performance feedback may be recorded into a model feedback log 338 by the AI/ML server process 336. In some embodiments, execution model failure is a reason for immediate feedback.

In some embodiments, the API 334 includes an interface to provide AI/ML model 332 feedback after an AI/ML model 332 execution response has been processed. This mechanism may be used to evaluate the performance of the AI/ML model 332 by enabling the API caller to provide feedback on the accuracy of the model results. In some embodiments, the feedback interface includes the identifier of the initial request so that it can be used to associate the feedback with the request. Upon receiving a call into the feedback interface of API 334, the AI/ML server process 336 records the feedback in the model feedback log 338. In some embodiments, the data in this model feedback log 338 is provided to model performance monitoring 356 in the AI/ML development system 340. This log data is streamed to the AI/ML development system 340 in one embodiment. In some embodiments, the log data is provided upon request.

A number of the decisions/steps that may utilize the AI/ML process described herein include: storing a plurality of articles of content within a data store, ingesting user data from an external data source, wherein the user data comprises contextual attributes of a user, fusing together content from an article among the plurality of articles and the user data to generate a fused article based on execution of an artificial intelligence (AI) model on the contextual attributes of the user and the content from the article, embedding a clickable link to a web page within a body of the fused article, and displaying the fused article on a user device of the user.

A number of the decisions/steps that may utilize the AI/ML process described herein include: generating an article of content based on execution of an artificial intelligence (AI) model on contextual attributes of a user and a plurality of articles stored within a data store, embedding a product within the article of content, displaying the article of content via a user interface of a user device and embedding an add to cart function associated with the product into the user interface, detecting an input with respect to the add to cart function displayed within the user interface, and in response to the detected input, displaying a notification on the user interface with a cart that includes the product therein.

The decisions/steps may also include: selecting a different article of content from among the plurality of articles based on execution of the AI model on the content from the article and the contextual attributes of the user, receiving a user identifier from the user device and the ingesting comprises querying the external data source for the user data based on the user identifier, wherein the external data source comprises one or more of a social media service, a user profile, and an externally hosted user account. In 823, the method may include ingesting a browsing history of the user from a browser installed on the user device and identifying the contextual attributes of the user from the browsing history of the user. In 824, the method may include executing a machine learning model on the contextual attributes of the user to identify a goal of the user, wherein the fusing together further comprises executing the AI model on the goal of the user identified by the machine learning model to generate the fused article. In 825, the method may include generating a new portion of content based on execution of the AI model on the contextual attributes of the user and the content from the article and inserting the new portion of content into the content of the article to generate the fused article. In 826, the method may include embedding comprises embedding the clickable link into the new portion of content within the fused article and activating the clickable link such that when clicked on, a user interface navigates to the web page. In 827, the method may include training the AI model based on execution of the AI model on a corpus of articles of content from a plurality of websites and user data attributes of a plurality of users, prior to fusing together the content from the article with the user data.

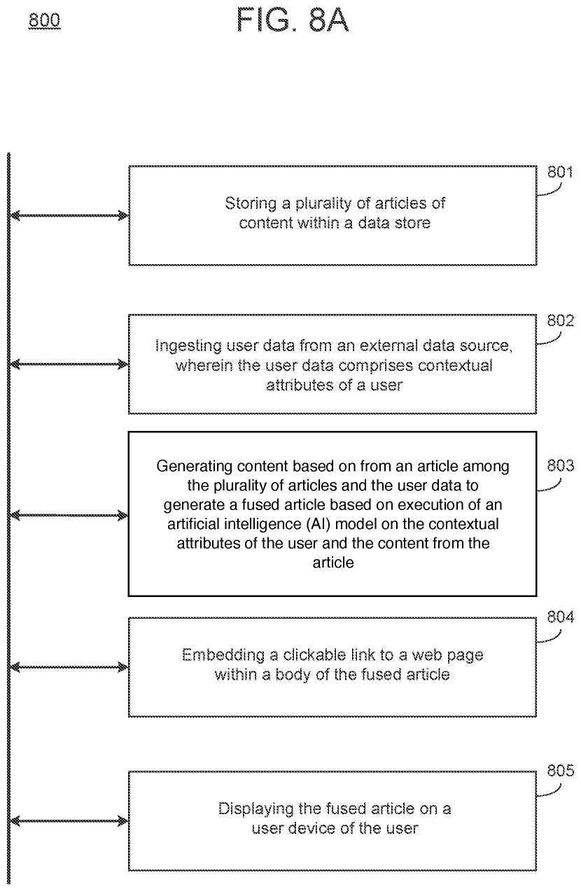

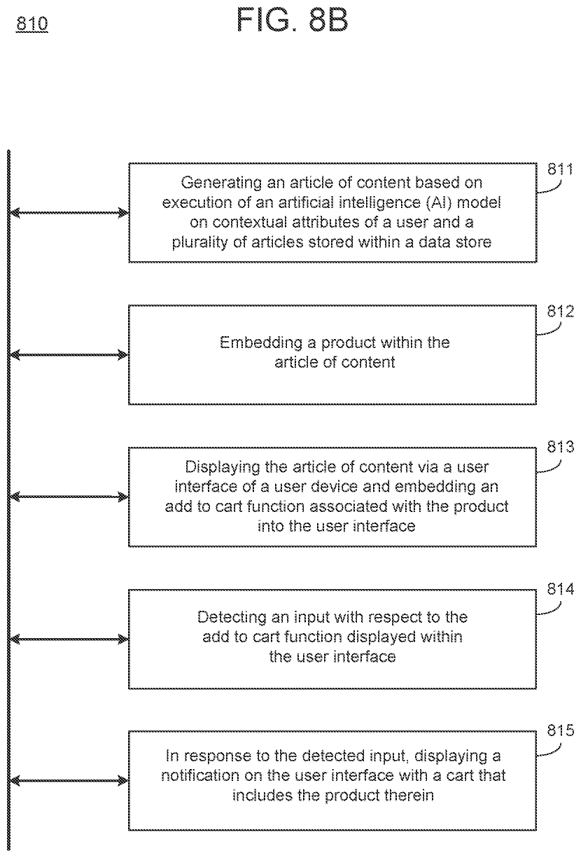

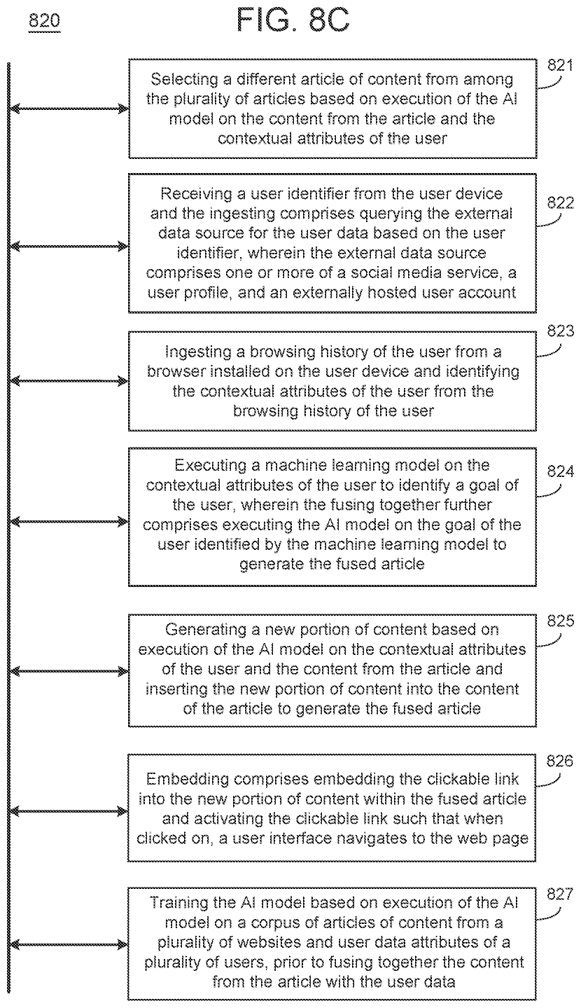

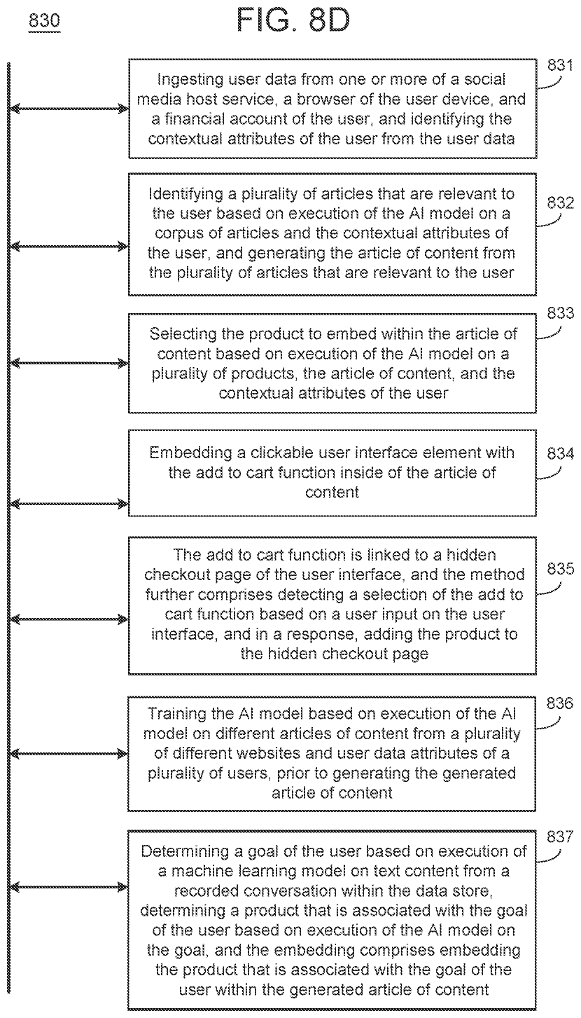

FIG. 8D illustrates another example flow diagram according to example embodiments. As an example, the method 830 may be performed by a computing system, a software application, a server, a cloud platform, a combination of systems, and the like. Referring to FIG. 8D, in 831, the method may include ingesting user data from one or more of a social media host service, a browser of the user device, and a financial account of the user, and identifying the contextual attributes of the user from the user data. In 832, the method may include identifying a plurality of articles that are relevant to the user based on execution of the AI model on a corpus of articles and the contextual attributes of the user, and generating the article of content from the plurality of articles that are relevant to the user. In 833, the method may include selecting the product to embed within the article of content based on execution of the AI model on a plurality of products, the article of content, and the contextual attributes of the user. In 834, the method may include embedding a clickable user interface element with the add to cart function inside of the article of content. In 835, the method may include the add to cart function is linked to a hidden checkout page of the user interface, and the method further comprises detecting a selection of the add to cart function based on a user input on the user interface, and in a response, adding the product to the hidden checkout page. In 836, the method may include training the AI model based on execution of the AI model on different articles of content from a plurality of different websites and user data attributes of a plurality of users, prior to generating the generated article of content. In 837, the method may include determining a goal of the user based on execution of a machine learning model on text content from a recorded conversation within the data store, determining a product that is associated with the goal of the user based on execution of the AI model on the goal, and the embedding comprises embedding the product that is associated with the goal of the user within the generated article of content.

Data associated with any of these steps/features, as well as any other features or functionality described or depicted herein, the AI/ML production system 330, as well as one or more of the other elements depicted in FIG. 3C may be used to process this data in a pre-transformation and/or post-transformation process.

According to various embodiments, the AI model described herein may be trained based on custom defined prompts that are designed to draw out specific attributes associated with a goal of a user. These same prompts may be output during live execution of the AI model. For example, a user may input a description of a goal and possibly other attributes. The description/attributes can then be used by the AI model to generate a custom image that enables the user to visualize the goal. The prompts may be generated via prompt engineering that can be performed through the model training process such as the model training process described above in the examples of FIGS. 3A-3C.

Prompt engineering is the process of structuring sentences (prompts) to be understood by an AI model and refining the prompts to generate optimal output from the AI model. A prompt may include a combination of a query that is asked of a user, and a response from the user to the query. As an example, the model may ask the user to describe products of interest offered by a service provider such as a financial institution. The user may respond with text, speech, etc., providing a description of the products of interest they would like to read about. Some or all of this information may be input to the AI model and used to create a custom article of content with infused user data. Part of the prompting process may include delays/waiting times that are intentionally included within the script such that the model has time understand and process the input data.

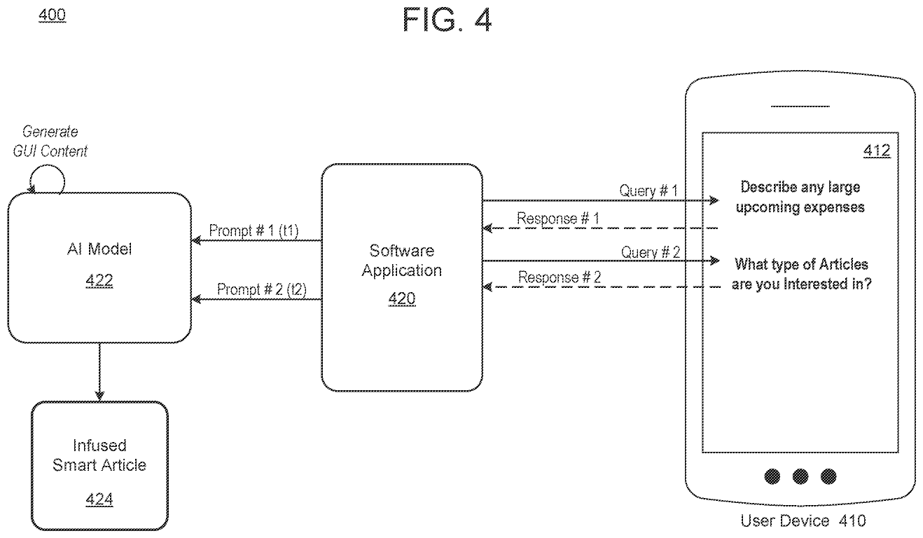

FIG. 4 illustrates a process 400 of an AI model 422 (e.g., a generative AI model, etc.) generating a smart article 424 infused with user data based on prompts according to example embodiments. Referring to FIG. 4, the AI model 422 may be hosted by a host platform (not shown) and may be part of a software application 420 that is also hosted on the host platform. Here, the software application 420 may establish a connection, such as a secure network connection, with a user device 410. The secure connection may be established by the user device 410 uploading a personal identification number (PIN), biometric scan, password, username, transport layer security (TLS) handshake, etc.

In the example of FIG. 4, the software application 420 may control the interaction of the AI model 422 on the host platform and the user device 410. In this example, the software application 420 may output queries on a user interface 412 of the user device 410 with requests for information from the user. The user may enter values into the fields on the user interface corresponding to the queries and submit/transfer both the query by the model and the response by the user as a “prompt” to the software application 420, for example, by pressing a submit button, etc. Each prompt may include multiple components including one or more of context, an instruction, input data, and an expected response/output.

In the example of FIG. 4, the software application 420 may combine the query with the response to generate a prompt that is then submitted to the AI model 422 during training of the AI model 422. For example, each prompt may include a combination of a query output by the AI model 422 and the response from the user. For example, if the query is “Describe any large upcoming expenses” and the response is “I am purchasing an automobile later this year and I'm interested in purchasing a house in the next 3 years”, then the text from both the query and the response to the query may be submitted to the AI model 422.

In some embodiments, the software application 420 may deliberately add waiting times between submitting prompts to the AI model 422 to ensure that the model has enough time to process the input. The waiting times may be integrated into the source code of the software application 420 and/or they may be modified/configured via a user interface. Furthermore, the ordering of the prompts and the follow-up queries that are asked may be different depending on the responses given during the previous prompt or prompts. The content within the prompts and the ordering of the prompts can be used by the AI model 422 to infuse existing article content and user data to generate new infused smart articles.

This instant solution describes a novel process of using an AI model trained on ingested article content and externally sourced user data to generate and display a smart content article based on context for the user where the article contains a link to a product page. It produces clickable articles that lead to products that are offered. Generative models like GANs (Generative Adversarial Networks) and variants of transformer models are designed to create new content based on patterns they identify in their training data. For this solution, the articles supplied to train the model can include financial data as well as social data. As another example, the model may be provided with behaviors, preferences, browsing history, and any other relevant data that may help the AI model understand and generate smart articles.

Context can be derived from the user data. The context may include previous articles that have been viewed by the user, purchasing preferences, family information about the user, career information about the user, life status information about the user (e.g., whether they have children, are married, have a home, are interested in saving for college, etc.) The context can also be dynamic. For example, the context on a Monday morning might be different than a Friday evening. Similarly, a user browsing during a sale season might have different preferences than during regular days. The AI model might also factor in real-time events, trends, or seasonal information to make the content more current and relevant. The smart article may also be embedded with a link that directs the user to another/different web page such as another article of content, a product page, a shopping cart, or the like.

In some embodiments, the instant solution is directed to a process using an AI model trained on a plurality of ingested article content and user data externally sourced to identify relevant articles based on the user context and article relevance. The solution then generates a new article of content based on contextual user attributes and relevant article content and displays the generated article of content on a user interface. In some embodiments, the generated article of content may be displayed simultaneously along with one or more other articles. The process begins by sourcing articles based on customer-specific interests and contextual data about the user. These articles, as well as the user data, are sourced from multiple external data sources. An AI model is then trained on the data to understand patterns, styles, and preferences in the data.

The AI model can identify which articles are relevant to a particular user based on this training. This relevancy is determined by two main factors: the user's context (which may include their browsing history, interactions, preferences, etc.) and the inherent relevance of the article content itself. The AI model now generates a new article with tailored content based on contextual user attributes, meaning it considers factors specific to the user's current situation, behavior, or preferences. Additionally, it uses relevant content from the articles on which it was trained to ensure the generated article is coherent and aligns with the user's interests. Once the new article is generated, it isn't displayed in isolation. Instead, it's shown alongside one or more other relevant articles. This offers the user a richer experience, giving them fresh AI-generated content and other articles that might interest them. The simultaneous display ensures that users have multiple reading options at their fingertips, increasing the chances of engagement.

In some embodiments, the instant solution is directed to a process that uses an AI model trained on a data store of articles and recorded call transcripts between two users to determine a goal of the user as well as article items associated with the goal and then generating an article of content that describes an item associated with the goal and displaying it on a user interface. The process begins by collecting a repository consisting of two main types of data: articles and recorded call transcripts. The articles can be from various sources, providing information, explanations, and descriptions about different topics. The call transcripts are textual representations of recorded calls between the customer and the advisor,

Using the information from the recorded call transcripts, the AI model analyzes the conversation to determine the user's objectives or intentions. This may involve recognizing patterns, keywords, or topics of interest expressed by the users during their conversation. Once the user's goal is identified, the AI model searches through its article data to find content or items that are relevant to or associated with the identified goal. After identifying the relevant articles and items associated with the user's goal, the AI model creates a new piece of content. This content aims to describe or explain the item in a manner that aligns with the user's goal, ensuring it is pertinent and useful to the user. The final step involves presenting the generated article to the user. This is done through a user interface, which may be a software application, a web page, or any digital platform where users can easily view and interact with the content.

In some embodiments, the instant solution describes a process of using an AI model trained on a data store of articles and user data to generate an article of content and an embedded product within the article content, then displaying the article with an add to cart function on a user interface. The process may detect an input on the add to cart function and display a notification on a user interface with the product in a cart. The instant solution employs an AI model trained on a unique combination of article and user data. This includes various articles possibly spanning different topics, writing styles, structures, etc. The user data contains information about user preferences, behaviors, interactions, and other relevant metrics that give insights into what content the user might prefer.

By being trained on a vast dataset of articles and user data, the AI model can produce content that mirrors the style, tone, and quality of top-tier articles. Once the article content is generated, the instant solution seamlessly embeds a product within this content. This may be in the form of a product mention, a review, or even a relevant placement that aligns with the context of the article. The embedded product might be chosen based on the user's past behavior, the context of the article, a combination of both, or the like. The generated article, with the embedded product, is then displayed on a user interface. Integrated within this article is an interactive add to cart function. This function allows users to immediately act upon their interests without navigating away from the article. The instant solution is intuitive enough to detect user inputs or interactions with the add to cart function. This may be a click, a touch gesture, or a predefined interaction method. Upon interaction with the add to cart feature, the user interface immediately provides feedback as a notification. This notification confirms that the product has been successfully added to the user's cart, reassuring them of their action and guiding them to the next steps, whether continuing reading, browsing other products, or proceeding to the cart.

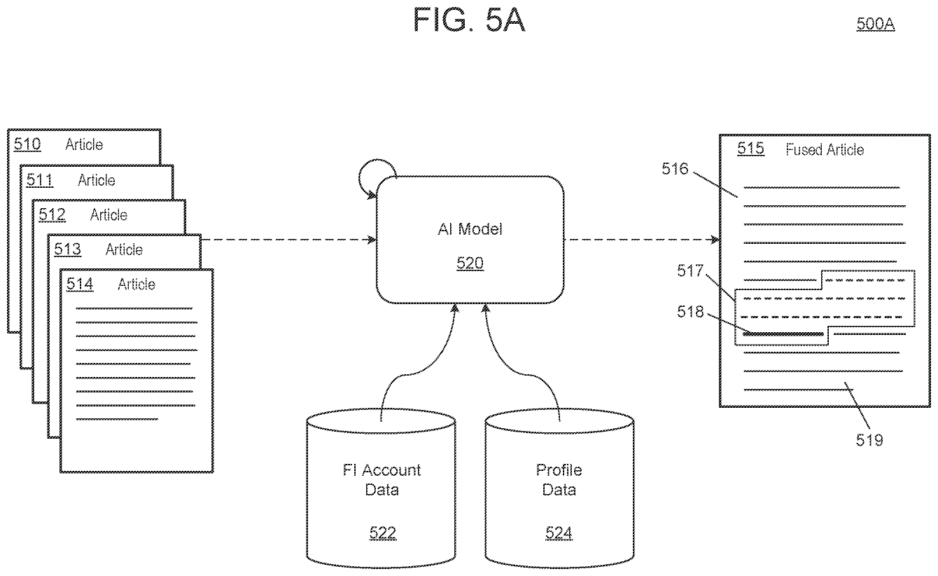

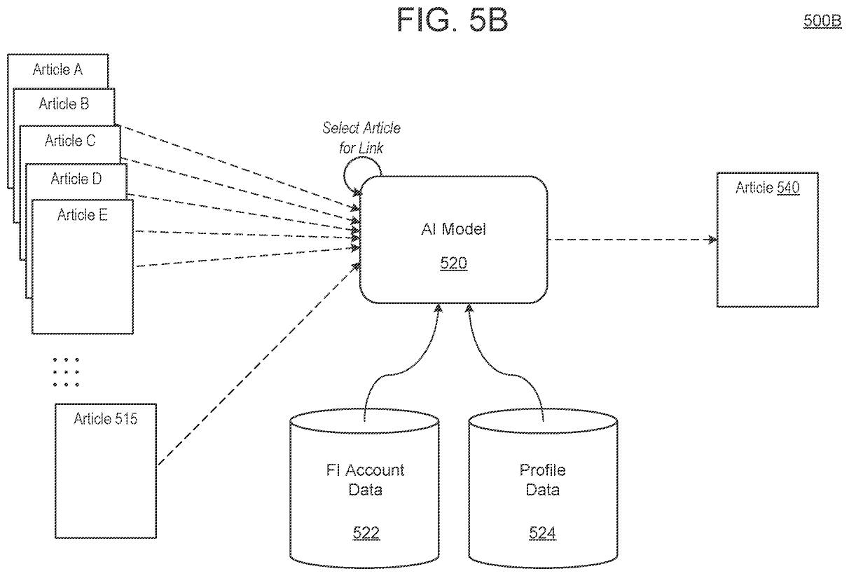

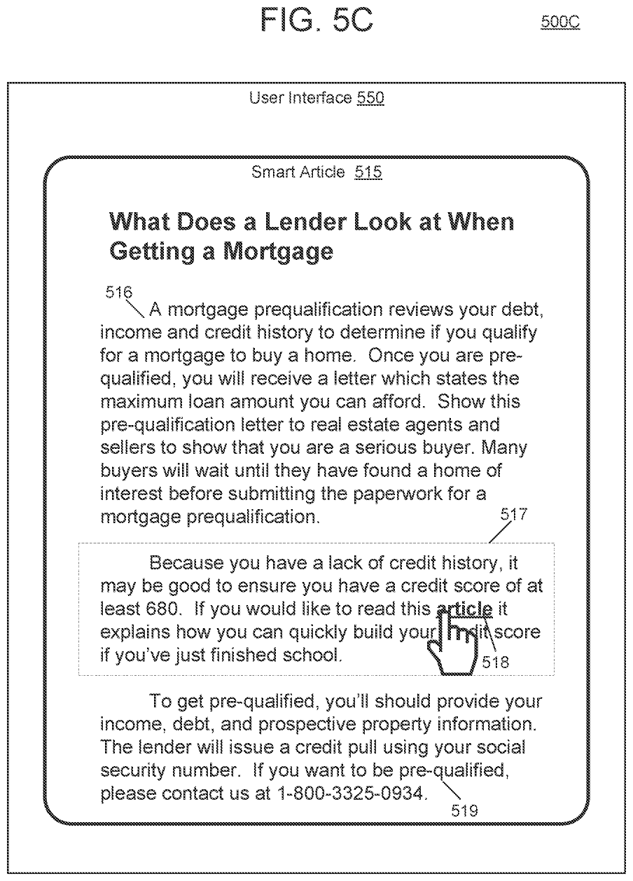

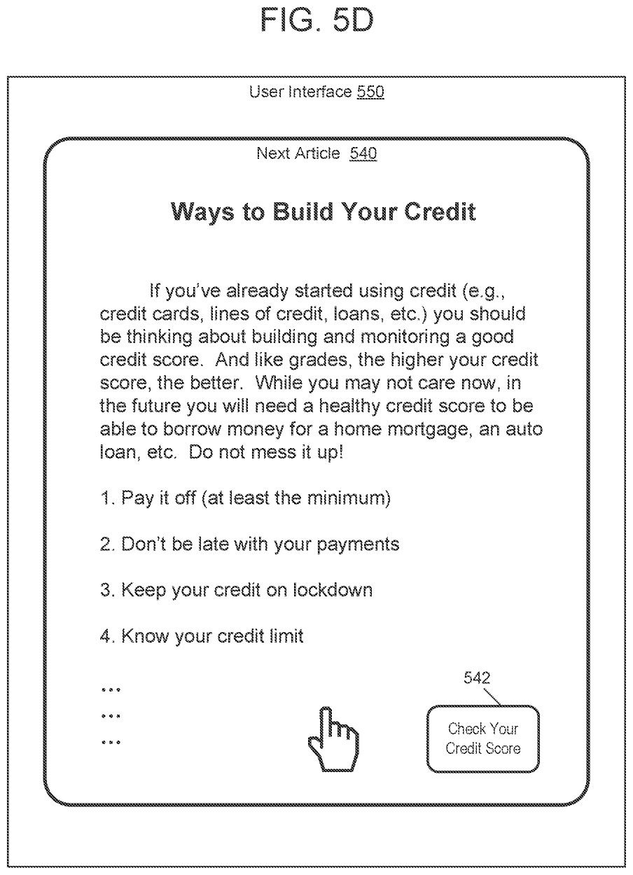

FIGS. 5A-5D illustrate a process of generating a fused article that is infused with user data according to example embodiments. For example, FIG. 5A illustrates a process 500A of generating a fused article 515 based on a combination of existing article content and user data that is fused together to generate a new article of content that is particular to a user. In this example, a host platform (not shown) hosts an AI model 520, such as a generative AI model. Here, the AI model 520 may ingest one or more articles of content from a data store such as data store 125 shown in FIG. 1. In FIG. 5A, the AI model 520 ingests an article 510, an article 511, an article 512, an article 513, and an article 514. The AI model 520 may use parts of one or more of the article 510, the article 511, the article 512, the article 513, and the article 514 to generate the new article 515.

For example, the AI model 520 may extract parts of a first article and fuse it together with parts of a second article (or more articles) to generate an article that is new. Furthermore, the AI model 520 may ingest user data from a data store 522 and/or a data store 524 and fuse the user data into new article content that can be incorporated into the fused article 515. As an example, the user data may include contextual attributes of the user such as family information, work information, user profiles, financial account data, profile data from a social media service, career building service, etc., browsing history, and the like. In this example, the AI model 520 may generate a sentence, a paragraph, etc. of content that describes specific user information and also information relevant to the fused article 515 being generated.

For example, in FIG. 5A, the fused article 515 includes a first part 516 of content from the article 512, a second part 519 from the article 513, and new content 517 generated from the user data and infused into the fused article 515 between the first part 516 and the second part 519. The new content 517 may include sentences of content, paragraphs of content, images, drawings, and the like which can be fused together with other article content to make a customized article that is specifically tailored based on the user's data. The new content 517 may be infused between existing parts of content from existing articles. As another example, the new content 517 may be embedded at the end of an article, at the beginning, and the like.

In addition to generating the new content 517, the AI model 520 may also select a next page (e.g., article of content, product page, etc.) that the user will be interested in viewing and embed a link 518 into the fused article 515. The link 518 may be embedded within one or more of the new content 517, the part 516, the part 519, or the like.

For example, FIG. 5B illustrates a process 500B of the AI model 520 selecting a next article 540 for the user to read. The next article 540 may be navigated by clicking on the link 518 embedded in the infused article 515 shown in FIG. 5A. Here, the AI model 520 may ingest a plurality of different articles and identify the next article 540 based on the fused article 515 and the user data from the data store 522 and/or the data store 524. The content of the next article 540 may be related to the fused article 515. In some embodiments, the next article 540 may be an article of content that is already existing. As another example, the next article 540 may be another/different fused article. The AI model 520 may select and/or generate the next article 540 based on the content within the fused article 515.

FIG. 5C illustrates a detailed view 500C of the fused article 515 shown in FIG. 5A. As shown in the example of FIG. 5C, the fused smart article 515 includes the first part 516 which is a textual description of the benefits of a mortgage pre-qualification process and the second part 519 which is a description of how to obtain a mortgage pre-qualification. As an example, the AI model 520 may determine that the user is recently employed in a particular geographic location and interested in purchasing a home in that location. The AI model 520 may also determine the user's current status based on the user data and determine that the fused smart article 515 should contain content about improving the user's credit score because the user has a credit score that is lower than desired. The AI model 520 may create the first part 516 and the second part 519, or the AI model 520 may obtain the first part 516 and/or the second part 519 from an existing article about getting pre-qualified for a mortgage.

According to various embodiments, the AI model 520 may also generate the new content 517 based on user information and merge it into the first part 516 and the second part 519 about the mortgage pre-qualification process. Here, the AI model 520 identifies a credit score of the user from the ingested user data and determines that the user credit score is risky for first-time home buyers. As such, the AI model 520 may identify a second article (shown on FIG. 5D) that is directed to improving their credit score. The AI model may embed a link (the link 518) to the second article 540 within the body of the fused article 515. For example, the link 518 may be embedded within the new content 517 that is specific to the user. As another example, the link 518 may be embedded somewhere else in the article or on a user interface 550 where the article is being displayed. Here, the user interface 550 may correspond to the user interface of a user device such as the user device 110 shown in FIG. 1.

The user may use a cursor and click on the link 518 within the article of content. In response, the user interface 550 may navigate to a view of the second article 540 as shown in the example of FIG. 5D. In this example, the second article 540 is selected from a group of existing articles. However, it should also be appreciated that the second article 540 may be a fused article that includes both article content and user data fused together to create a second customized article of content for the user.

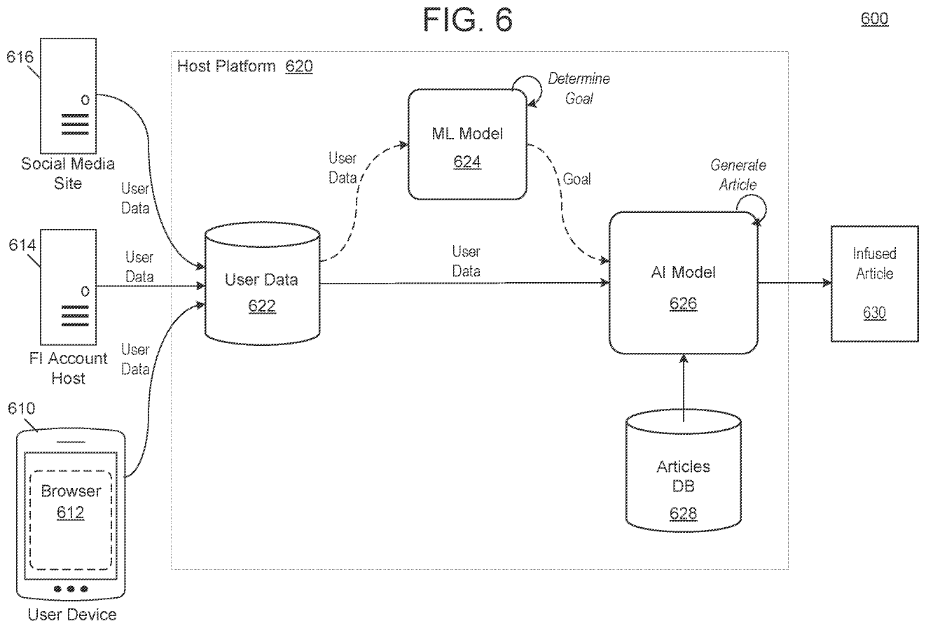

FIG. 6 illustrates a process 600 of ingesting user data for generating a fused smart article according to example embodiments. Referring to FIG. 6, a host platform 620 may host an AI model 626 that is capable of generating infused smart articles of content that include a combination of article content and user data fused together. Here, the host platform 620 may ingest user data from various sources. For example, the host platform 620 may query a user device 610 for browsing history from a browser 612 installed on the user device 610. As another example, the host platform 620 may query a financial account of the user from a financial account host server 614. As another example, the host platform 620 may query social media posts, profiles, content, and the like from a host server 616 of a social media site.

The user data returned from the data sources may be stored within a user data store 622. Here, the user data includes context about the user such as family information, work information, spending information, social interests, and the like. In some embodiments, the user data 622 may be input directly to the AI model 626. As another example, the user data 622 may be input to a machine learning model 624 which can determine a goal of the user based on the user data. As an example, the goal may be a goal of purchasing a new car, a goal of saving for a college education, a goal of financing a small business, etc. The goal that is determined by the ML model 624 may be input to the AI model 626 instead of the user data or in addition to the user data. Thus, the AI model 626 may have a greater amount of information to use when generating a new smart article 630 with infused content.

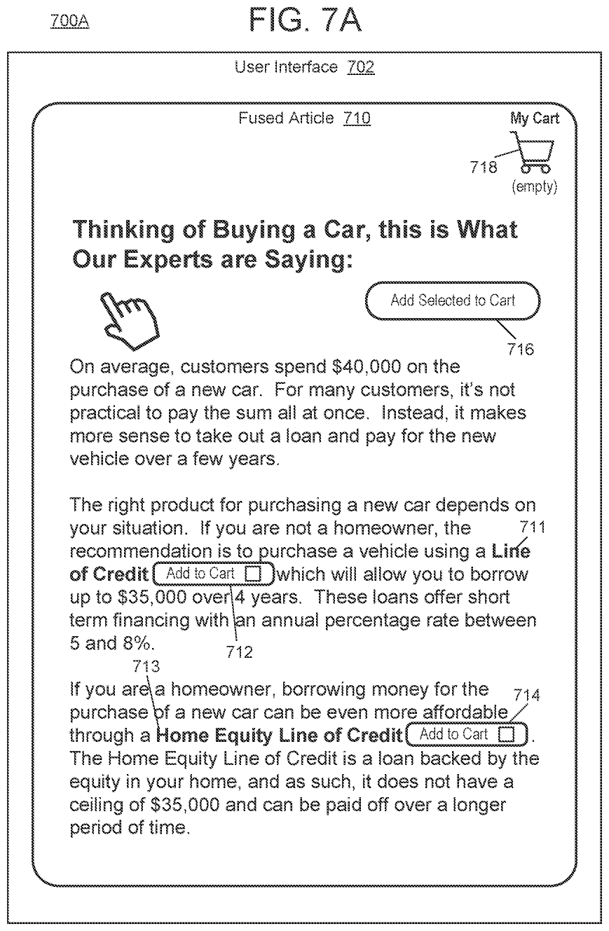

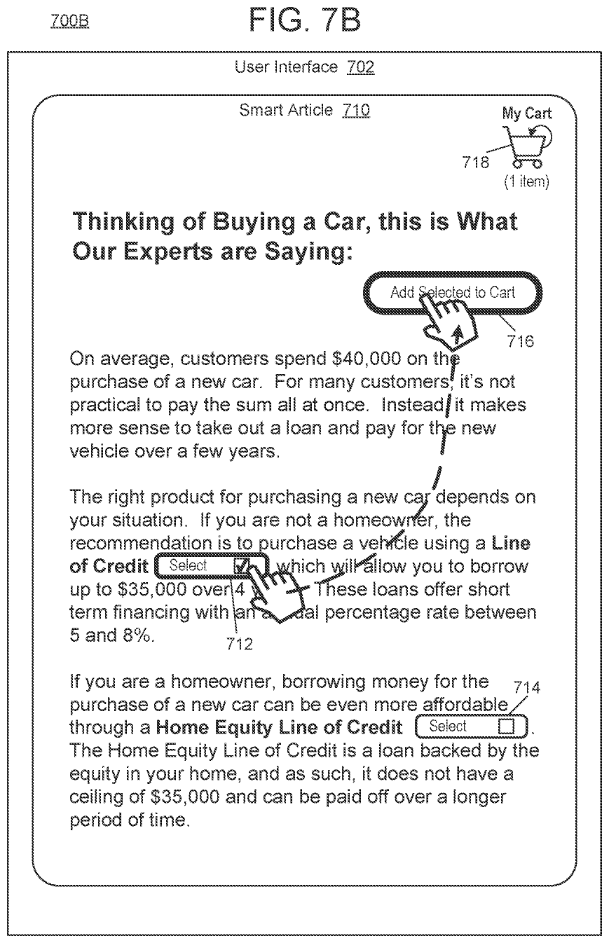

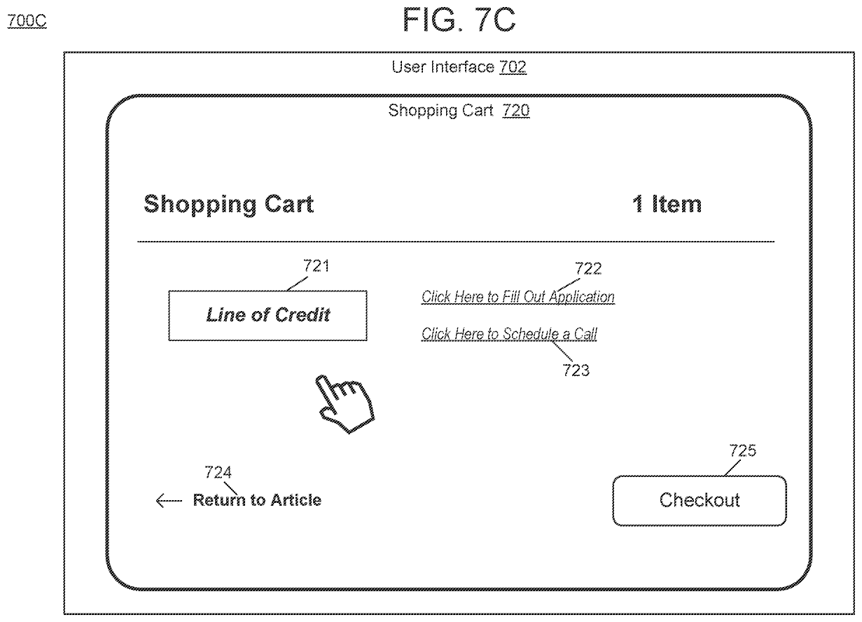

FIGS. 7A-7C illustrate a process of embedding an add to cart function within an article of content according to example embodiments. In the examples of FIGS. 7A-7C, an AI model may generate a new article of content or use an existing article of content and embed products into the article. For example, the model may embed an identifier of the product, such as the product name, an application for the product, a cost of the product, and the like. In addition, the product may be linked to an add to cart button or another type of user interface element. When the product is selected and the add to cart button is also selected, the product may be added to a shopping cart.

In these examples, the AI model may generate a fused article or use an existing article and embed both products and an add to cart functionality into the generated article. For example, FIG. 7A illustrates a process 700A of displaying a fused article 710 based on user data obtained about a user via a user interface 702, such as a user interface of a user device, etc. The fused article 710 includes content that is relevant to the user. In this example, the content is directed to educating the user about purchasing a new car. The article explains the cost of a new car and how customers can finance the car over a period of time. This article may be based on the user's current financial status.

In addition, the AI model also embeds clickable products into the fused article 710 that the user can select to finance an automobile purchase. For example, the AI model may embed a product 711 and a product 713 associated with financing an automobile loan. Here, the AI model also embeds a selectable element 712 in association with the product 711 and a selectable element 714 in association with the product 713. The selectable element 712 and the selectable element 714 can be selected by a user. Furthermore, the AI model may embed an add to cart function 716 and a shopping cart indicator 718. In this example, the shopping cart is empty, therefore the shopping cart indicator 718 indicates that no items are included in the shopping cart.

For example, FIG. 7B illustrates a process 700B of a user activating the add to cart function 716 embedded within the infused article 710 displayed via the user interface 702. Referring to FIG. 7B, the user may use a cursor to select one or more of the products 711 and 713 (shown in FIG. 7A) by clicking on a respective selectable element of the respective products using a cursor, a finger, etc. via the user interface 702. Here, the user has clicked on the selectable element 712 that corresponds to the product 711. In addition, the user may click on the add to cart function 716 (e.g., button, etc.) causing all selected products to be transferred to the shopping cart. Here, the product 711 is transferred to the shopping cart. The user interface 702 may update/refresh the shopping cart indicator 718 to indicate that one item is now included in the shopping cart.

Thus, the user can read the article and add products to the shopping cart at the same time. For example, the shopping cart indicator 718 can be updated in real-time to indicate that the product has been added to the shopping cart. FIG. 7C illustrates a shopping cart page 720 that the user can open by clicking on the shopping cart indicator 718 shown in FIG. 7B. Here, the shopping cart page 720 includes an identifier of the product 721 along with application instructions 722 for completing the purchase, and appointment instructions 723 for scheduling a call with any questions about the product. The shopping cart page 720 also includes a navigation function 724 which, when selected, traverses the user interface 702 back to the infused article 710. In addition, the shopping cart page 720 includes a checkout button 725, which when selected, brings the user to a payment screen, or some other screen for finalizing the purchase such as an application completed page, etc.

FIG. 8A illustrates a method 800 of generating a smart article infused with user content and an embedded link according to example embodiments. As an example, the method 800 may be performed by a computing system, a software application, a server, a cloud platform, a combination of systems, and the like. Referring to FIG. 8A, in 801, the method may include storing a plurality of articles of content within a data store. For example, the articles of content may include text, images, drawings, and the like, which are downloaded from websites, blogs, posts, social media sites, and the like.

In 802, the method may include ingesting user data from an external data source, wherein the user data comprises contextual attributes of a user. The contextual attributes may include context of the user such as a browsing history of the user, user profiles, financial account behavior, social media activity, and the like. In 803, the method may include fusing together content from an article among the plurality of articles and the user data to generate a fused article based on execution of an artificial intelligence (AI) model on the contextual attributes of the user and the content from the article. The AI model may use an existing/historical article and embed user-specific data into the article that generates a “custom” article of content that is particular to the user's interests. In 804, the method may include embedding a clickable link to a web page within a body of the fused article. In 805, the method may include displaying the fused article on a user device of the user.

In some embodiments, the web page corresponding to the clickable link may correspond to a different article of content, and the method further include selecting the different article of content from among the plurality of articles based on execution of the AI model on the content from the article and the contextual attributes of the user. In some embodiments, the method may further include receiving a user identifier from the user device and the ingesting comprises querying the external data source for the user data based on the user identifier, wherein the external data source comprises one or more of a social media service, a user profile, and an externally hosted user account. In some embodiments, the ingesting may include ingesting a browsing history of the user from a browser installed on the user device and identifying the contextual attributes of the user from the browsing history of the user.

In some embodiments, the method may further include executing a machine learning model on the contextual attributes of the user to identify a goal of the user. In this example, the fusing together may include executing the AI model on the goal of the user identified by the machine learning model to generate the infused article. In some embodiments, the fusing together may include generating a new portion of content based on execution of the AI model on the contextual attributes of the user and the content from the article and inserting the new portion of content into the content of the article to generate the infused article.

In some embodiments, the embedding may include embedding the clickable link into the new portion of content within the infused article and activating the clickable link such that when clicked on, a user interface navigates to the web page. In some embodiments, the method may further include training the AI model based on execution of the AI model on a corpus of articles of content from a plurality of websites and user data attributes of a plurality of users, prior to fusing together the content from the article with the user data.

FIG. 8B illustrates a method 810 of generating an article of content with an add to cart function according to example embodiments. As an example, the method 810 may be performed by a computing system, a software application, a server, a cloud platform, a combination of systems, and the like. Referring to FIG. 8B, in 811, the method may include generating an article of content based on execution of an artificial intelligence (AI) model on contextual attributes of a user and a plurality of articles stored within a data store. In 812, the method may include embedding a product within the article of content, In 813, the method may include displaying the article of content via a user interface of a user device and embedding an add to cart function associated with the product into the user interface. In 814, the method may include detecting an input with respect to the add to cart function displayed within the user interface. In 815, the method may include in response to the detected input, displaying a notification on the user interface with a cart that includes the product therein.

In some embodiments, the method may further include ingesting user data from one or more of a social media host service, a browser of the user device, and a user profile of the user, and identifying the contextual attributes of the user from the user data. In some embodiments, the generating may include identifying a plurality of articles that are relevant to the user based on execution of the AI model on a corpus of articles and the contextual attributes of the user, and generating the article of content from the plurality of articles that are relevant to the user, In some embodiments, the method may further include selecting the product to embed within the article of content based on execution of the AI model on a plurality of products, the article of content, and the contextual attributes of the user.

In some embodiments, the embedding may include embedding a clickable user interface element with the add to cart function inside of the article of content. In some embodiments, the add to cart function may be linked to a hidden checkout page of the user interface, and the method may further include detecting a selection of the add to cart function based on a user input on the user interface, and in a response, adding the product to the hidden checkout page. In some embodiments, the method may further include training the AI model based on execution of the AI model on different articles of content from a plurality of different websites and user data attributes of a plurality of users, prior to generating the generated article of content. In some embodiments, the method may further include determining a goal of the user based on execution of a machine learning model on text content from a recorded conversation within the data store, determining a product that is associated with the goal of the user based on execution of the AI model on the goal, and the embedding may include embedding the product that is associated with the goal of the user within the generated article of content.

FIG. 8C illustrates an example flow diagram according to example embodiments. As an example, the method 820 may be performed by a computing system, a software application, a server, a cloud platform, a combination of systems, and the like. Referring to FIG. 8C, in 821, the method may include selecting a different article of content from among the plurality of articles based on execution of the AI model on the content from the article and the contextual attributes of the user. In 822, the method may include receiving a user identifier from the user device and the ingesting comprises querying the external data source for the user data based on the user identifier, wherein the external data source comprises one or more of a social media service, a user profile, and an externally hosted user account. In 823, the method may include ingesting a browsing history of the user from a browser installed on the user device and identifying the contextual attributes of the user from the browsing history of the user. In 824, the method may include executing a machine learning model on the contextual attributes of the user to identify a goal of the user, wherein the fusing together further comprises executing the AI model on the goal of the user identified by the machine learning model to generate the fused article. In 825, the method may include generating a new portion of content based on execution of the AI model on the contextual attributes of the user and the content from the article and inserting the new portion of content into the content of the article to generate the fused article. In 826, the method may include embedding comprises embedding the clickable link into the new portion of content within the fused article and activating the clickable link such that when clicked on, a user interface navigates to the web page. In 827, the method may include training the AI model based on execution of the AI model on a corpus of articles of content from a plurality of websites and user data attributes of a plurality of users, prior to fusing together the content from the article with the user data.

FIG. 8D illustrates another example flow diagram according to example embodiments. As an example, the method 830 may be performed by a computing system, a software application, a server, a cloud platform, a combination of systems, and the like. Referring to FIG. 8D, in 831, the method may include ingesting user data from one or more of a social media host service, a browser of the user device, and a financial account of the user, and identifying the contextual attributes of the user from the user data. In 832, the method may include identifying a plurality of articles that are relevant to the user based on execution of the AI model on a corpus of articles and the contextual attributes of the user, and generating the article of content from the plurality of articles that are relevant to the user. In 833, the method may include selecting the product to embed within the article of content based on execution of the AI model on a plurality of products, the article of content, and the contextual attributes of the user. In 834, the method may include embedding a clickable user interface element with the add to cart function inside of the article of content. In 835, the method may include the add to cart function is linked to a hidden checkout page of the user interface, and the method further comprises detecting a selection of the add to cart function based on a user input on the user interface, and in a response, adding the product to the hidden checkout page. In 836, the method may include training the AI model based on execution of the AI model on different articles of content from a plurality of different websites and user data attributes of a plurality of users, prior to generating the generated article of content. In 837, the method may include determining a goal of the user based on execution of a machine learning model on text content from a recorded conversation within the data store, determining a product that is associated with the goal of the user based on execution of the AI model on the goal, and the embedding comprises embedding the product that is associated with the goal of the user within the generated article of content.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), digital versatile disk read-only memory (“DVD-ROM”), or any other form of storage medium known in the art.

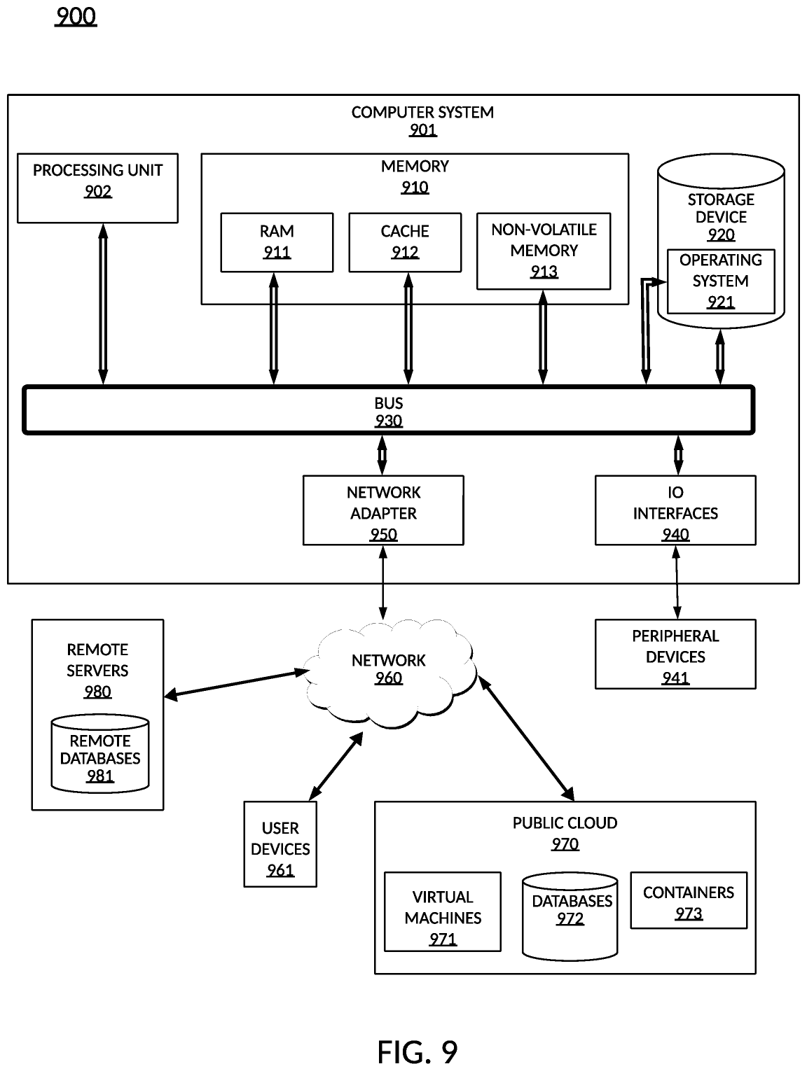

An exemplary storage medium may be coupled to the processor such that the processor may read information from, and write information to, the storage medium. In the alternative, the storage medium may be integral to the processor. The processor and the storage medium may reside in an application specific integrated circuit (“ASIC”). In the alternative, the processor and the storage medium may reside as discrete components. For example, FIG. 9 illustrates an example computer system architecture, which may represent or be integrated in any of the above-described components, etc.

FIG. 9 illustrates a computing environment according to example embodiments. FIG. 9 is not intended to suggest any limitation as to the scope of use or functionality of embodiments of the application described herein. Regardless, the computing environment 900 can be implemented to perform any of the functionalities described herein. In computer environment 900, there is a computer system 901, operational within numerous other general-purpose or special-purpose computing system environments or configurations.

Computer system 901 may take the form of a desktop computer, laptop computer, tablet computer, smartphone, smartwatch or other wearable computer, server computer system, thin client, thick client, network PC, mini computer system, mainframe computer, quantum computer, and distributed cloud computing environment that include any of the described systems or devices, and the like or any other form of computer or mobile device now known or to be developed in the future that is capable of running a program, accessing a network 960 or querying a database. Depending upon the technology, the performance of a computer-implemented method may be distributed among multiple computers and among multiple locations. However, in this presentation of the computing environment 900, a detailed discussion is focused on a single computer, specifically computer system 901, to keep the presentation as simple as possible.

Computer system 901 may be located in a cloud, even though it is not shown in a cloud in FIG. 9. On the other hand, computer system 901 is not required to be in a cloud except to any extent as may be affirmatively indicated. Computer system 901 may be described in the general context of computer system-executable instructions, such as program modules, executed by a computer system 901. Generally, program modules may include routines, programs, objects, components, logic, data structures, and so on that perform tasks or implement certain abstract data types. As shown in FIG. 9, computer system 901 in computing environment 900 is shown in the form of a general-purpose computing device. The components of computer system 901 may include, but are not limited to, one or more processors or processing units 902, a system memory 910, and a bus 930 that couples various system components, including system memory 910 to processor 902.

Processing unit 902 includes one or more computer processors of any type now known or to be developed. The processing unit 902 may contain circuitry distributed over multiple integrated circuit chips. The processing unit 902 may also implement multiple processor threads and multiple processor cores. Cache 912 is a memory that may be in the processor chip package(s) or may be located “off-chip,” as depicted in FIG. 9. Cache 912 is typically used for data or code that should be available for rapid access by the threads or cores running on the processing unit 902. In some computing environments, processing unit 902 may be designed to work with qubits and perform quantum computing.

Memory 910 is any type of volatile memory now known or to be developed in the future. Examples include dynamic type random access memory (RAM) 911 or static type RAM 911. Typically, the volatile memory is characterized by random access, but this is not required unless affirmatively indicated. In computer system 901, memory 910 is located in a single package and is internal to computer system 901, but alternatively or additionally, the volatile memory may be distributed over multiple packages and/or located externally with respect to computer system 901. By way of example only, memory 910 can be provided for reading from and writing to a non-removable, non-volatile magnetic media (shown as storage device 920, and typically called a “hard drive”). Memory 910 may include at least one program product having a set (e.g., at least one) of program modules that are configured to carry out the functions of various embodiments of the application. A typical computer system 901 may include cache 912, a type of specialized volatile memory generally faster than RAM 911 and generally located closer to the processing unit 902. Cache 912 stores frequently accessed data and instructions accessed by the processing unit 902 to speed up processing time. The computer system 901 may also include non-volatile memory 913 in the form of ROM, PROM, EEPROM, and flash memory. Non-volatile memory 913 often contains programming instructions for starting the computer, including the basic input/output system (BIOS) and information required to start the operating system 921.

Computer system 901 may include a removable/non-removable, volatile/non-volatile computer storage device 920. By way of example only, storage device 920 can be a non-removable, non-volatile magnetic media (not shown and typically called a “hard drive”). It can be connected to the bus 930 by one or more data interfaces. In embodiments where computer system 901 is required to have a large amount of storage (for example, where computer system 901 locally stores and manages a large database), then this storage may be provided by peripheral storage devices 920 designed for storing very large amounts of data, such as a storage area network (SAN) that is shared by multiple, geographically distributed computers.

The operating system 921 is software that manages computer system 901 hardware resources and provides common services for computer programs. Operating system 921 may take several forms, such as various known proprietary operating systems or open-source Portable Operating System Interface type operating systems that employ a kernel.

The bus 930 represents one or more of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. The bus 930 is the signal conduction path that allows the various components of computer system 901 to communicate with each other.

Computer system 901 may also communicate with one or more peripheral devices 941 via an input/output (I/O) interface 940. Such devices may include a keyboard, a pointing device, a display, etc.; one or more devices that enable a user to interact with computer system 901; and/or any devices (e.g., network card, modem, etc.) that enable computer system 901 to communicate with one or more other computing devices. Such communication can occur via I/O interfaces 940. As depicted, IO interface 940 communicates with the other components of computer system 901 via bus 930.

Network adapter 950 enables the computer system 901 to connect and communicate with one or more networks 960, such as a local area network (LAN), a wide area network (WAN), and/or a public network (e.g., the Internet). It bridges the computer's internal bus 930 and the external network, allowing data to be exchanged efficiently and reliably. Network adapter 950 may include hardware, such as modems or Wi-Fi signal transceivers, software for packetizing and/or de-packetizing data for communication network transmission. Network adapter 950 supports various communication protocols to ensure compatibility with network standards. For Ethernet connections, it adheres to protocols such as IEEE 802.3, while for wireless communications, it might support IEEE 802.11 standards, Bluetooth, near-field communication (NFC), or other network wireless radio standards.

Network 960 is any computer network that can receive and/or transmit data. Network 960 can include a WAN, LAN, private cloud, or public Internet, capable of communicating computer data over non-local distances by any technology for communicating computer data now known or to be developed in the future. Any connection depicted can be wired and/or wireless and may traverse other components that are not shown. In some embodiments, a network 960 may be replaced and/or supplemented by LANs designed to communicate data between devices located in a local area, such as a Wi-Fi network. The network 960 typically includes computer hardware such as copper transmission cables, optical transmission fibers, wireless transmission, routers, firewalls, switches, gateway computers, edge servers, and network infrastructure known now or to be developed in the future. Computer system 901 connects to network 960 via network adapter 950 and bus 930.

User devices 961 are any computer systems used and controlled by an end user in connection with computer system 901. For example, in a hypothetical case where computer system 901 is designed to provide a recommendation to an end user, this recommendation would typically be communicated from network adapter 950 of computer system 901 through network 960 to a user device 961, allowing user device 961 to display, or otherwise present, the recommendation to an end user. User devices can be a wide array of devices, including personal computers (PCs), laptop computers, tablet computers, hand-held computers, mobile phones, etc.

A public cloud 970 is on-demand availability of computer system resources, including data storage, and computing power, without direct active management by the user. Public clouds 970 are often distributed, with data centers in multiple locations for availability and performance. Computing resources on public clouds 970 are shared across multiple tenants through virtual computing environments comprising virtual machines 971, databases 972, containers 973, and other resources. A container 973 is an isolated, lightweight software for running an application on the host operating system 921. Containers 973 are built on top of the host operating system's kernel and contain only applications and some lightweight operating system APIs and services. In contrast, virtual machines 971 are a software layer which include a complete operating system 921 and kernel. Virtual machines 971 are built on top of a hypervisor emulation layer designed to abstract a host computer's hardware from the operating software environment. Public clouds 970 generally offer hosted databases 972 abstracting high-level database management activities.

Remote servers 980 are any computers that serve at least some data and/or functionality over a network 960, for example, WAN, a virtual private network (VPN), a private cloud, or via the Internet to computer system 901. These networks 960 may communicate with a LAN to reach users. The user interface may include a web browser or an application that facilitates communication between the user and remote data. Such applications have been referred to as “thin” desktop applications or “thin clients.” Thin clients typically incorporate software programs to emulate desktop sessions. Mobile applications can also be used. Remote servers 980 can also host remote databases 981, with the database located on one remote server 980 or distributed across multiple remote servers 980. Remote databases 981 are accessible from database client applications installed locally on the remote server 980, other remote servers 980, user devices 961, or computer system 901 across a network 960.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” may be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code may be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

1. An apparatus comprising:
a memory; and
a processor coupled to the memory, the processor configured to:
detect a request to open an article via a software application, retrieve data of a user associated with the request from a data store, execute an artificial intelligence (AI) model on the data of the user and one or more articles of content to generate a unique article that includes user data infused with article content,
identify, via the AI model, an object that is related to the user data and the unique article and infuse a description of the object and a graphical user interface (GUI) element configured to select the object within the unique article to generate a unique infused article,
display the unique infused article and a graphical icon via a GUI on a page of the software application,
detect an input on the GUI element within the unique infused article via the GUI on the page of the software application, and
in response to the detected input, add the object to a second page of the software application and refresh the graphical icon on the GUI with modified content to indicate the object has been added.

2. The apparatus of claim 1, wherein the processor is configured to retrieve the data from one or more of a social media host service, a browser of a source device, and a financial account of the user, and identify contextual attributes of the user from the data.

3. The apparatus of claim 1, wherein the processor is configured to identify a plurality of articles that are relevant to the user based on execution of the AI model on a corpus of articles and the data of the user, and generate the unique article from the plurality of articles that are relevant to the user.

4. The apparatus of claim 1, wherein the processor is further configured to select the object to embed within the article of content based on execution of the AI model on a plurality of objects, the unique article, and the data of the user.

5. The apparatus of claim 1, wherein the processor is configured to embed a clickable button with an add to cart function inside of the unique article.

6. The apparatus of claim 1, wherein the graphical icon is linked to a hidden page of the software application, and the processor is configured to add the object to the hidden page of the software application.

7. The apparatus of claim 1, wherein the processor is further configured to train the AI model based on execution of the AI model on different articles of content from a plurality of different websites and user data attributes of a plurality of users.

8. The apparatus of claim 1, wherein the processor is further configured to determine an objective of the user based on execution of a machine learning model on text content from a recorded conversation, and determine the object based on execution of the AI model on the objective of the user.

9. A method comprising:
detecting a request to open an article via a software application;
retrieving data of a user associated with the request from a data store;
executing an artificial intelligence (AI) model on the data of the user and one or more articles of content to generate a unique article that includes user data infused with article content;
identifying, via the AI model, an object that is related to the user data and the unique article and infusing a description of the object and a graphical user interface (GUI) element configured to select the object within the unique article to generate a unique infused article;
displaying the unique infused article and a graphical icon via a GUI on a page of the software application;
detecting an input on the GUI element within the unique infused article via the GUI on the page of the software application; and
in response to the detected input, adding the object to a second page of the software application and refresh the graphical icon on the GUI with modified content to indicate the object has been added.

10. The method of claim 9, wherein the retrieving comprises retrieving the data from one or more of a social media host service, a browser of a source device, and a financial account of the user, and identifying contextual attributes of the user from the data.

11. The method of claim 9, wherein the executing comprises identifying a plurality of articles that are relevant to the user based on execution of the AI model on a corpus of articles and the data of the user, and generating the unique article from the plurality of articles that are relevant to the user.

12. The method of claim 9, wherein the method further comprises selecting the object to embed within the article of content based on execution of the AI model on a plurality of objects, the unique article, and the data of the user,

13. The method of claim 9, wherein the infusing comprises embedding a clickable button with an add to cart function inside of the unique article.

14. The method of claim 9, wherein the graphical icon is linked to a hidden page of the software application, and adding comprises adding the object to the hidden page of the software application.

15. The method of claim 9, wherein the method further comprises training the AI model based on execution of the AI model on different articles of content from a plurality of different websites and user data attributes of a plurality of users.

16. The method of claim 9, wherein the method further comprises determining an objective of the user based on execution of a machine learning model on text content from a recorded conversation, and determining the object based on execution of the AI model on the objective of the user.

17. A computer-readable storage medium comprising instructions stored therein which when executed by a processor cause the processor to perform:
detecting a request to open an article via a software application;
retrieving data of a user associated with the request from a data store;
executing an artificial intelligence (AI) model on the data of the user and one or more articles of content to generate a unique article that includes user data infused with article content;
identifying, via the AI model, an object that is related to the user data and the unique article and infusing a description of the object and a graphical user interface (GUI) element configured to select the object within the unique article to generate a unique infused article;
displaying the unique infused article and a graphical icon via a GUI on a page of the software application;
detecting an input on the GUI element within the unique infused article via the GUI on the page of the software application; and
in response to the detected input, adding the object to a second page of the software application and refresh the graphical icon on the GUI with modified content to indicate the object has been added.

18. The computer-readable storage medium of claim 17, wherein the retrieving comprises retrieving the data from one or more of a social media host service, a browser of a source device, and a financial account of the user, and identifying contextual attributes of the user from the data.

19. The computer-readable storage medium of claim 17, wherein the executing comprises identifying a plurality of articles that are relevant to the user based on execution of the AI model on a corpus of articles and the data of the user, and generating the unique article from the plurality of articles that are relevant to the user.

20. The computer-readable storage medium of claim 17, wherein the processor performs selecting the object to embed within the article of content based on execution of the AI model on a plurality of objects, the unique article, and the data of the user.
